(19) United States
(12) Patent Application Publication
(10) Pub. No.: US 2009/0196141 A1
(43) Pub. Date: Aug. 6, 2009

(54) OPTICAL RECORDING MEDIUM, METHOD FOR UTILIZING DYE COMPOUND AND VISIBLE INFORMATION RECORDING METHOD

(75) Inventors: Hisashi Mikoshiba, Shizuoka-ken (JP); Michihiro Shibata, Kanagawa-ken (JP); Yoshihiko Fujie, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/302,864

(22) PCT Filed: May 30, 2007
(86) PCT No.: PCT/JP2007/060970

§ 371 Date: Nov. 28, 2008

(30) Foreign Application Priority Data
May 31, 2006 (JP) 2006-151526

(51) Int. Cl. G11B 7/00; B32B 3/02

(52) U.S. Cl. 369/100; 428/64.8; G9B/7

(57) ABSTRACT

An optical recording medium has a constitution wherein a visible information recording medium section and an information recording medium section are bonded through a bonding layer. The visible information recording medium section has a constitution wherein a visible information recording layer, a first reflection layer and a first protection layer are stacked on a first substrate. The information recording medium section has a constitution wherein an information recording layer, a second reflection layer and a second protection layer are stacked on a second substrate having a pregroove formed on the surface. The visible information recording layer contains at least one dye compound among a yellow dye compound, magenta dye compound and a cyan dye compound.

### TECHNICAL FIELD

The present invention relates to an optical recording medium, and specifically to an optical recording medium having a visible information recording layer on which visible information can be recorded by using a laser light, a method of using a dye compound for a material of the visible information recording layer, and a method of recording visible information on the optical recording medium.

### BACKGROUND ART

In several known optical recording media such as CD-Rs and DVD-Rs, electronic information is recorded on a data recording layer on a recording surface of a substrate, and a label is attached to the reverse surface. Visible information of the contents of the recorded electronic information, such as a song title of music data or a title for identifying recorded data, is printed on the label. Such an optical recording medium is produced by printing a title or the like on a circular label sheet using a printer, and by attaching the printed label sheet to the reverse surface.

Thus, in addition to a disc drive, the printer such as an ink-jet printer is needed to produce the optical recording medium with the visible information (a desired visible image such as a title) recorded. The electronic information is recorded by the disc drive on the recording surface of the optical recording medium, the optical recording medium is removed from the disc drive, and then the label sheet printed by the printer, as separately prepared is attached thereto. Therefore, complicated operations are required for producing the optical recording medium.

An optical recording medium having a data recording surface and a reverse surface, on which visible information can be displayed by contrasting the information with the background using a laser marker, is proposed in Patent Document 1, etc. In the optical recording medium having this structure, by using only an optical disc drive, desired visible information can be recorded on the label surface without printers.

In the optical recording medium having the label surface on which desired visible information can be recorded, a data recording layer capable of recording electronic information and a visible information recording layer capable of recording and displaying the visible information are formed using a reflective layer therebetween. The visible information recording layer contains a dye for recording high-contrast visible information.

For example, a visible light property changing layer is formed in a position viewable from the label surface of the optical disc. The visible light property of the layer from the label surface, such as a color property (e.g. color hue, brightness, saturation), spectrum, reflectance, transmittance, or light scattering, is changed by irradiating the label surface with a laser light (see Patent Document 2, etc).

In Patent Document 2, the optical disc is set on a turntable of an optical disc device such that the label surface is oriented toward the laser light irradiation, and the laser light from the optical pickup is relatively moved along the surface of the optical disc. The laser light from the optical pickup is modulated in accordance with image data of a character, a picture, etc. to be displayed synchronously with the relative movement. The visible light property changing layer is irradiated with the laser light from the label surface, and the visible light property thereof is changed by the irradiation to form visible information on the label surface.

In this method of forming the visible information on the label surface, the visible light property changing layer is formed in a position viewable from the label surface of the optical disc, and the visible light property of the layer is changed by irradiating the layer with the laser light, whereby visible information such as a character or picture is displayed on the label surface. Thus, the method does not require pen writing, printing using a printer, etc.

### [Patent Document 1] Japanese Laid-Open Patent Publication No. 11-066617

### [Patent Document 2] Japanese Laid-Open Patent Publication No. 2002-203321

### DISCLOSURE OF THE INVENTION

An optical recording medium, particularly an optical recording medium capable of recording visible information such as a visible image is different in required properties from general digital data recording media.

An object of the present invention is to provide an optical recording medium, on which high-contrast, clear, visible information can be recorded even in the case of using a system different from conventional drive systems (i.e. a system capable of recording visible information on a visible information recording layer), a method for using a dye compound, and a method for recording visible information.

An optical recording medium according to a first aspect of the present invention comprises a substrate and a visible information recording layer formed thereon, and is characterized in that visible information is recorded on the visible information recording layer by applying a laser light to the visible information recording layer repeatedly in an approximately same trajectory pattern while oscillating the laser light in the radial direction of the substrate, and the visible information recording layer comprises at least one dye compound selected from dye compounds represented by the following general formula (1), dye compounds represented by the following general formula (2), and dye compounds represented by the following general formula (3).

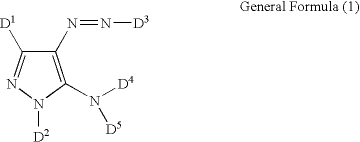

In the general formula (1), D¹ represents a hydrogen atom or a monovalent substituent, D² represents a hydrogen atom or a monovalent substituent, D³ represents an aromatic group, and D⁴ and D⁵ independently represent a hydrogen atom or a monovalent substituent. Each monovalent substituent may further have a substituent.

In the general formula (1), D¹ may be a hydrogen atom, an alkyl group, an alkoxy group, an aryl group, an alkoxycarbonyl group, a cyano group, or a carbamoyl group, D² may be a hydrogen atom, an alkyl group, an aryl group, or a heteroaryl group, D³ may be an aryl group or a heteroaryl group, and D⁴ and D⁵ may be independently a hydrogen atom or an alkyl group.

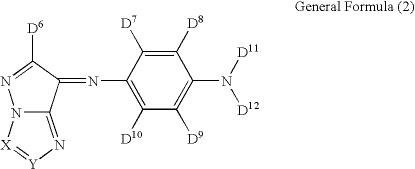

In the general formula (2), D⁶ to D¹² independently represent a hydrogen atom or a monovalent substituent. D¹¹ and D¹² may be bonded to each other to form a ring, and D⁸ and D¹¹ and/or D⁹ and D¹² may be bonded to form a ring. X and Y each represent a nitrogen atom or ═C(D¹³)- (in which D¹³ represents a hydrogen atom, an alkyl group, an aryl group, an alkoxy group, an aryloxy group, or an amino group). When both X and Y are C(D¹³)-, two D¹³, may be bonded to each other to form a saturated or unsaturated carbocyclic ring. Each monovalent substituent may further have a substituent.

In the general formula (2), it is preferred that D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D¹¹ and D¹² are independently a hydrogen atom, an alkyl group, or an aryl group.

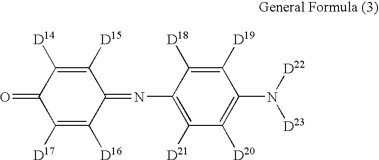

In the general formula (3), D¹⁴ to D²¹ independently represent a hydrogen atom or a monovalent substituent, D²² and D²³ independently represent a hydrogen atom or a monovalent substituent. D²² and D²³ may be bonded to each other to form a ring, and D¹⁹ and D²² and/or D²⁰ and D²³ may be bonded to form a ring.

In the general formula (3), it is preferred that D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D²² and D²³ are independently a hydrogen atom, an alkyl group, or an aryl group.

Thus, according to the first aspect of the present invention, there are provided the following optical recording media.

### [First Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (1).

### [Second Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (2).

### [Third Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (3).

### [Fourth Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (1) and a dye compound represented by the general formula (2).

### [Fifth Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (1) and a dye compound represented by the general formula (3).

### [Sixth Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (2) and a dye compound represented by the general formula (3).

### [Seventh Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern while oscillating the laser light in the radial direction of the substrate, wherein the visible information recording layer comprises a dye compound represented by the general formula (1), a dye compound represented by the general formula (2), and a dye compound represented by the general formula (3).

The optical information recording medium of the first aspect of the present invention is capable of recording high-contrast, clear, visible information with excellent fastness, even in the case of using a system for recording visible information such as a visible image on a visible information recording layer (e.g. a system described in Japanese Laid-Open Patent Publication No. 2002-203321).

Thus, the optical recording medium of the present invention capable of recording visible information is different in required properties from common digital data recording media. In digital data recording, a pit is formed by single irradiation with a laser light. Therefore, the optical recording medium capable of visible information recording is different in required properties from common optical digital data recording media.

In the digital data recording, generally it is important to form, on a data recording layer, pits with reflectance and modulation degrees sufficient for recognition of an optical disc drive. A substrate adjacent to the data recording layer in the optical recording medium has guide grooves, and the pits are regularly recorded in the guide grooves. Thus, a dye in the data recording layer needs to exhibit such a pyrolysis behavior that the pits can be uniformly formed in the guide grooves highly reproducibly in the laser beam irradiation process.

Meanwhile, a dye contained in a visible information recording layer is not used in combination with such guide grooves in some cases. The dye need not function to regularly form uniform pits, but has to form a larger pit to make an unrecorded region between the pit and the adjacent track as narrow as possible.

Further, in the visible information recording method, a system for repeatedly applying a laser light in an approximately same trajectory pattern or a system for oscillating (vibrating) a laser light in the radial direction of the optical disc and/or repeatedly applying a laser light in an approximately same trajectory pattern is used as described in Japanese Laid-Open Patent Publication No. 2002-203321.

The optical recording medium of the first aspect of the present invention (the first to seventh optical recording media) may further comprise a phthalocyanine dye represented by the following general formula (4).

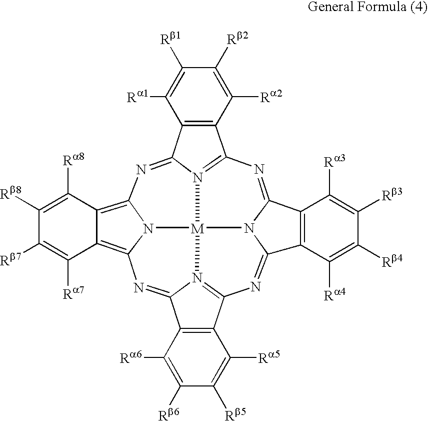

In the general formula (4), R^{α1}, to R^{α8} and R^{β1} to R^{β8} independently represent a hydrogen atom or a monovalent substituent, and M represents two hydrogen atoms, a metal, a metal oxide, or a metal having a ligand.

In the general formula (4), R^{α1} to R^{α8} and R^{β1} to R^{β8} may be independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

An optical recording medium according to a second aspect of the present invention comprises a substrate and a visible information recording layer formed thereon, and is characterized in that the visible information recording layer comprises at least one dye compound selected from dye compounds represented by the following general formula (1), dye compounds represented by the following general formula (2), and dye compounds represented by the following general formula (3).

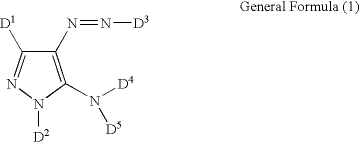

In the general formula (1), D¹ represents a hydrogen atom or a monovalent substituent, D² represents a hydrogen atom or a monovalent substituent, D³ represents an aromatic group, and D⁴ and D⁵ independently represent a hydrogen atom or a monovalent substituent. Each monovalent substituent may further have a substituent.

In the general formula (1), D¹ may be a hydrogen atom, an alkyl group, an alkoxy group, an aryl group, an alkoxycarbonyl group, a cyano group, or a carbamoyl group, D² may be a hydrogen atom, an alkyl group, an aryl group, or a heteroaryl group, D³ may be an aryl group or a heteroaryl group, and D⁴ and D⁵ may be independently a hydrogen atom or an alkyl group.

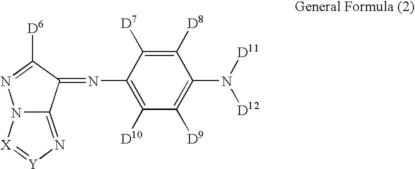

In the general formula (2), D⁶ to D¹² independently represent a hydrogen atom or a monovalent substituent. D¹¹ and D¹² may be bonded to each other to form a ring, and D⁸ and D¹¹ and/or D⁹ and D¹² may be bonded to form a ring. X and Y each represent a nitrogen atom or ═C(D¹³)- (in which D¹³ represents a hydrogen atom, an alkyl group, an aryl group, an alkoxy group, an aryloxy group, or an amino group). When both X and Y are C(D¹³)-, two D^{13′}, may be bonded to each other to form a saturated or unsaturated carbocyclic ring. Each monovalent substituent may further have a substituent.

In the general formula (2), it is preferred that D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D¹¹ and D¹² are independently a hydrogen atom, an alkyl group, or an aryl group.

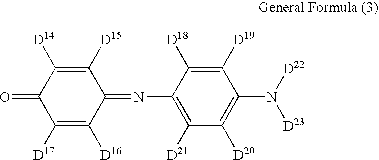

In the general formula (3), D¹⁴ to D²¹ independently represent a hydrogen atom or a monovalent substituent, D²² and D²³ independently represent a hydrogen atom or a monovalent substituent. D²² and D²³ may be bonded to each other to form a ring, and D¹⁹ and D²² and/or D²⁰ and D²³ may be bonded to form a ring.

In the general formula (3), it is preferred that D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D²² and D²³ are independently a hydrogen atom, an alkyl group, or an aryl group.

Thus, according to the second aspect of the present invention, there are provided the following optical recording media.

### [Eleventh Optical Recording Medium]

An optical recording medium comprising a substrate and a visible information recording layer formed thereon, wherein the visible information recording layer comprises a dye compound represented by the general formula (1).

### [Twelfth Optical Recording Medium]

An optical recording medium comprising a substrate and a visible information recording layer formed thereon, wherein the visible information recording layer comprises a dye compound represented by the general formula (2).

### [Thirteenth Optical Recording Medium]

An optical recording medium comprising a substrate and a visible information recording layer formed thereon, wherein the visible information recording layer comprises a dye compound represented by the general formula (3).

### [Fourteenth Optical Recording Medium]

An optical recording medium comprising a substrate and a visible information recording layer formed thereon, wherein the visible information recording layer comprises a dye compound represented by the general formula (1) and a dye compound represented by the general formula (2).

### [Fifteenth Optical Recording Medium]

An optical recording medium comprising a substrate and a visible information recording layer formed thereon, wherein the visible information recording layer comprises a dye compound represented by the general formula (1) and a dye compound represented by the general formula (3).

### [Sixteenth Optical Recording Medium]

An optical recording medium comprising a substrate and a visible information recording layer formed thereon, wherein the visible information recording layer comprises a dye compound represented by the general formula (2) and a dye compound represented by the general formula (3).

### [Seventeenth Optical Recording Medium]

An optical recording medium comprising a substrate and a visible information recording layer formed thereon, wherein the visible information recording layer comprises a dye compound represented by the general formula (1), a dye compound represented by the general formula (2), and a dye compound represented by the general formula (3).

The optical information recording medium of the second aspect of the present invention is capable of recording a high-contrast, clear, visible information with excellent fastness, even in the case of using a system for recording visible information on a visible information recording layer (e.g. a system described in Japanese Laid-Open Patent Publication No. 2002-203321).

The optical recording medium of the second aspect of the present invention (the eleventh to seventeenth optical recording media) may further comprise a phthalocyanine dye represented by the following general formula (4).

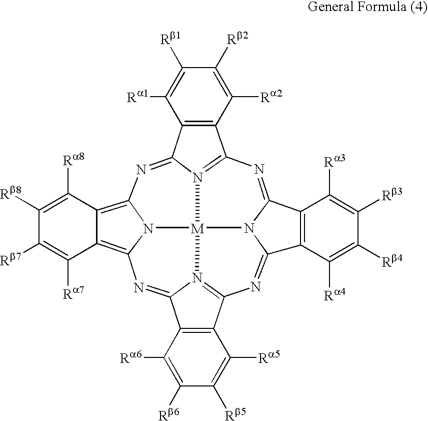

In the general formula (4), R^{α1} to R^{α8} and R^{β1} to R^{β8} independently represent a hydrogen atom or a monovalent substituent, and M represents two hydrogen atoms, a metal, a metal oxide, or a metal having a ligand.

In the general formula (4), R^{α1} to R^{α8} and R^{β1} to R^{β8} may be independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

An optical recording medium according to a third aspect of the present invention comprises a substrate and a visible information recording layer formed thereon, and is characterized in that visible information is recorded on the visible information recording layer by applying a laser light to the visible information recording layer repeatedly in an approximately same trajectory pattern, and the visible information recording layer comprises at least one dye compound selected from dye compounds represented by the following general formula (1), dye compounds represented by the following general formula (2), and dye compounds represented by the following general formula (3).

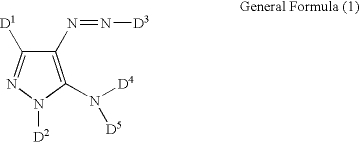

In the general formula (1), D¹ represents a hydrogen atom or a monovalent substituent, D² represents a hydrogen atom or a monovalent substituent, D³ represents an aromatic group, and D⁴ and D⁵ independently represent a hydrogen atom or a monovalent substituent. Each monovalent substituent may further have a substituent.

In the general formula (1), D¹ may be a hydrogen atom, an alkyl group, an alkoxy group, an aryl group, an alkoxycarbonyl group, a cyano group, or a carbamoyl group, D² may be a hydrogen atom, an alkyl group, an aryl group, or a heteroaryl group, D³ may be an aryl group or a heteroaryl group, and D⁴ and D⁵ may be independently a hydrogen atom or an alkyl group.

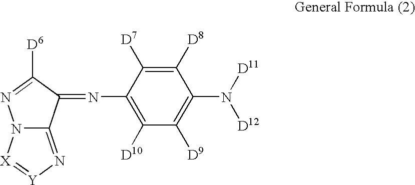

In the general formula (2), D⁶ to D¹² independently represent a hydrogen atom or a monovalent substituent. D¹¹ and D¹² may be bonded to each other to form a ring, and D⁸ and D¹¹ and/or D⁹ and D¹² may be bonded to form a ring. X and Y each represent a nitrogen atom or ═C(D¹³)- (in which D¹³ represents a hydrogen atom, an alkyl group, an aryl group, an alkoxy group, an aryloxy group, or an amino group). When both X and Y are C(D¹³)-, two D¹³'s may be bonded to each other to form a saturated or unsaturated carbocyclic ring. Each monovalent substituent may further have a substituent.

In the general formula (2), it is preferred that D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D¹¹ and D¹² are independently a hydrogen atom, an alkyl group, or an aryl group.

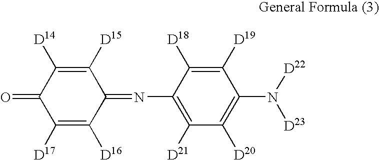

In the general formula (3), D¹⁴ to D²¹ independently represent a hydrogen atom or a monovalent substituent, D²² and D²³ independently represent a hydrogen atom or a monovalent substituent. D²² and D²³ may be bonded to form a ring, and D¹⁹ and D²² and/or D²⁰ and D²³ may be bonded to form a ring.

In the general formula (3), it is preferred that D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D²² and D²³ are independently a hydrogen atom, an alkyl group, or an aryl group.

Thus, according to the second aspect of the present invention, there are provided the following optical recording media.

### [Twenty-First Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (1).

### [Twenty-Second Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (2).

### [Twenty-Third Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (3).

### [Twenty-Fourth Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (1) and a dye compound represented by the general formula (2).

### [Twenty-Fifth Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (1) and a dye compound represented by the general formula (3).

### [Twenty-Sixth Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (2) and a dye compound represented by the general formula (3).

### [Twenty-Seventh Optical Recording Medium]

An optical recording medium comprising a substrate and a visible information recording layer formed thereon, visible information being recorded on the visible information recording layer by applying a laser light to the visible information recording layer repeatedly in an approximately same trajectory pattern, wherein the visible information recording layer comprises a dye compound represented by the general formula (1), a dye compound represented by the general formula (2), and a dye compound represented by the general formula (3).

The optical information recording medium of the third aspect of the present invention is capable of recording a high-contrast, clear, visible information with excellent fastness, even in the case of using a system for recording visible information on a visible information recording layer (e.g. a system described in Japanese Laid-Open Patent Publication No. 2002-203321).

The optical recording medium of the third aspect of the present invention (the twenty-first to twenty-seventh optical recording media) may further comprise a phthalocyanine dye represented by the following general formula (4).

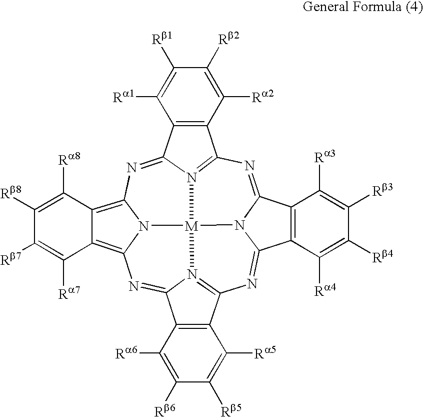

In the general formula (4), R^{α1} to R^{α8} and R^{β1} to R^{β8} independently represent a hydrogen atom or a monovalent substituent, and M represents two hydrogen atoms, a metal, a metal oxide, or a metal having a ligand.

In the general formula (4), R^{α1} to R^{α8} and R^{β1} to R^{β8} may be independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

A method according to a fourth aspect of the present invention is for using a dye compound in a material of a visible information recording layer in an optical recording medium comprising a substrate and the visible information recording layer formed thereon, and is characterized in that visible information is recorded on the visible information recording layer by applying a laser light to the visible information recording layer repeatedly in an approximately same trajectory pattern while oscillating the laser light in the radial direction of the substrate, and the material of the visible information recording layer comprises at least one dye compound selected from dye compounds represented by the following general formula (1), dye compounds represented by the following general formula (2), and dye compounds represented by the following general formula (3).

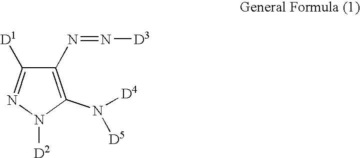

In the general formula (1), D¹ represents a hydrogen atom or a monovalent substituent, D² represents a hydrogen atom or a monovalent substituent, D³ represents an aromatic group, and D⁴ and D⁵ independently represent a hydrogen atom or a monovalent substituent. Each monovalent substituent may further have a substituent.

In the general formula (1), D¹ may be a hydrogen atom, an alkyl group, an alkoxy group, an aryl group, an alkoxycarbonyl group, a cyano group, or a carbamoyl group, D² may be a hydrogen atom, an alkyl group, an aryl group, or a heteroaryl group, D³ may be an aryl group or a heteroaryl group, and D⁴ and D⁵ may be independently a hydrogen atom or an alkyl group.

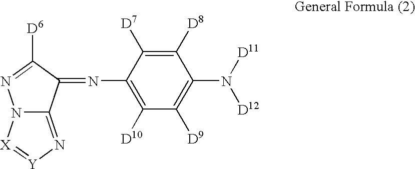

In the general formula (2), D⁶ to D¹² independently represent a hydrogen atom or a monovalent substituent. D¹¹ and D¹² may be bonded to each other to form a ring, and D⁸ and D¹¹ and/or D⁹ and D¹² may be bonded to form a ring. X and Y each represent a nitrogen atom or ═C(D¹³)- (in which D¹³ represents a hydrogen atom, an alkyl group, an aryl group, an alkoxy group, an aryloxy group, or an amino group). When both X and Y are C(D¹³)-, two D¹³'s may be bonded to each other to form a saturated or unsaturated carbocyclic ring. Each monovalent substituent may further have a substituent.

In the general formula (2), it is preferred that D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D¹¹ and D¹² are independently a hydrogen atom, an alkyl group, or an aryl group.

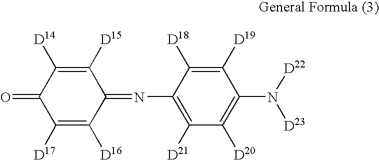

In the general formula (3), D¹⁴ to D²¹ independently represent a hydrogen atom or a monovalent substituent, D²² and D²³ independently represent a hydrogen atom or a monovalent substituent. D²² and D²³ may be bonded to each other to form a ring, and D¹⁹ and D²² and/or D²⁰ and D²³ may be bonded to form a ring.

In the general formula (3), it is preferred that D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D²² and D²³ are independently a hydrogen atom, an alkyl group, or an aryl group.

Thus, according to the third aspect of the present invention, there are provided the following methods of using a dye compound.

### [First Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (1).

### [Second Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (2).

### [Third Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (3).

### [Fourth Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (1) and a dye compound represented by the general formula (2).

### [Fifth Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (1) and a dye compound represented by the general formula (3).

### [Sixth Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (2) and a dye compound represented by the general formula (3).

### [Seventh Use Method]

A method of using a dye compound in a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in the radial direction of the substrate, wherein the material of the visible information recording layer comprises a dye compound represented by the general formula (1), a dye compound represented by the general formula (2), and a dye compound represented by the general formula (3).

In the method of the fourth aspect of the present invention, by using the dye compound in the optical recording medium having the visible information recording layer for recording visible information, a high-contrast, clear, visible information can be recorded with excellent fastness on the optical recording medium.

In the method of the fourth aspect of the present invention (the first to seventh use methods), the optical recording medium may further comprise a phthalocyanine dye represented by the following general formula (4).

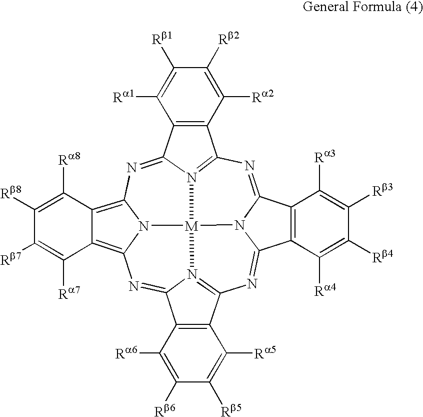

In the general formula (4), R^{α1} to R^{α8} and R^{β1} to R^{β8} independently represent a hydrogen atom or a monovalent substituent, and M represents two hydrogen atoms, a metal, a metal oxide, or a metal having a ligand.

In the general formula (4), R^{α1} to R^{α8} and R^{β1} to R^{β8} may be independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

A method according to a fifth aspect of the present invention is for recording visible information on an optical recording medium comprising a substrate and a visible information recording layer formed thereon, and is characterized in that the method comprises applying a laser light to the visible information recording layer repeatedly in an approximately same trajectory pattern while oscillating the laser light in the radial direction of the substrate, and the visible information recording layer comprises at least one dye compound selected from dye compounds represented by the following general formula (1), dye compounds represented by the following general formula (2), and dye compounds represented by the following general formula (3).

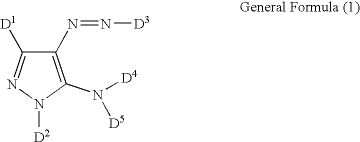

In the general formula (1), D¹ represents a hydrogen atom or a monovalent substituent, D² represents a hydrogen atom or a monovalent substituent, D³ represents an aromatic group, and D⁴ and D⁵ independently represent a hydrogen atom or a monovalent substituent. Each monovalent substituent may further have a substituent.

In the general formula (1), D¹ may be a hydrogen atom, an alkyl group, an alkoxy group, an aryl group, an alkoxycarbonyl group, a cyano group, or a carbamoyl group, D² may be a hydrogen atom, an alkyl group, an aryl group, or a heteroaryl group, D³ may be an aryl group or a heteroaryl group, and D⁴ and D⁵ may be independently a hydrogen atom or an alkyl group.

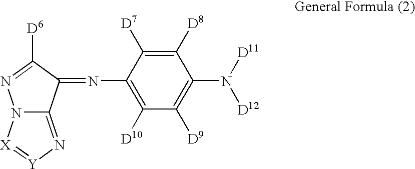

In the general formula (2), D⁶ to D³² independently represent a hydrogen atom or a monovalent substituent. D¹¹ and D¹² may be bonded to each other to form a ring, and D⁸ and D¹¹ and/or D⁹ and D¹² may be bonded to form a ring. X and Y each represent a nitrogen atom or ═C(D¹³)- (in which D¹³ represents a hydrogen atom, an alkyl group, an aryl group, an alkoxy group, an aryloxy group, or an amino group). When both X and Y are C(D¹³)-, two D¹³, may be bonded to each other to form a saturated or unsaturated carbocyclic ring. Each monovalent substituent may further have a substituent.

In the general formula (2), it is preferred that D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D¹¹ and D³² are independently a hydrogen atom, an alkyl group, or an aryl group.

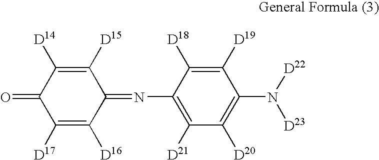

In the general formula (3), D¹⁴ to D²¹ independently represent a hydrogen atom or a monovalent substituent, D²² and D²³ independently represent a hydrogen atom or a monovalent substituent. D²² and D²³ may be bonded to form a ring, and D¹⁹ and D²² and/or D²⁰ and D²³ may be bonded to form a ring.

In the general formula (3), it is preferred that D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group. It is preferred that D²² and D²³ are independently a hydrogen atom, an alkyl group, or an aryl group.

Thus, according to the fifth aspect of the present invention, there are provided the following visible information recording methods.

### [First Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (1).

### [Second Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (2).

### [Third Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (3).

### [Fourth Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (1) and a dye compound represented by the general formula (2).

### [Fifth Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (1) and a dye compound represented by the general formula (3).

### [Sixth Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (2) and a dye compound represented by the general formula (2).

### [Seventh Visible Information Recording Method]

A method of recording visible information on an optical recording medium comprising a substrate and a visible information recording layer formed thereon, comprising applying a laser light to the visible information recording layer repeatedly in an approximately same trajectory pattern while oscillating the laser light in the radial direction of the substrate, wherein the visible information recording layer comprises a dye compound represented by the general formula (1), a dye compound represented by the general formula (2), and a dye compound represented by the general formula (3).

The visible information recording method of the fifth aspect of the present invention is capable of recording high-contrast, clear, visible information with excellent fastness, even in the case of using a system for recording visible information on a visible information recording layer (e.g. a system described in Japanese Laid-Open Patent Publication No. 2002-203321).

In the visible information recording method of the fifth aspect of the present invention (the 1st to 7th visible information recording methods), the optical recording medium may further comprise a phthalocyanine dye represented by the following general formula (4).

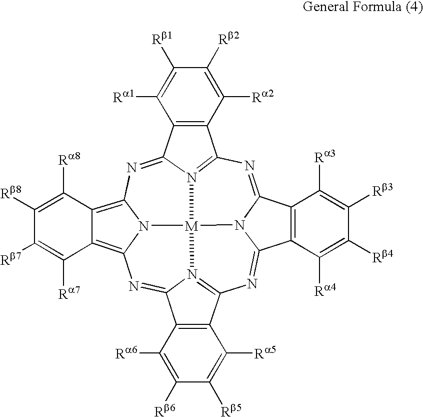

In the general formula (4), R^{α1} to R^{α8} and R^{β1} to R^{β8} independently represent a hydrogen atom or a monovalent substituent, and M represents two hydrogen atoms, a metal, a metal oxide, or a metal having a ligand.

In the general formula (4), R^{α1} to R^{α8} and R^{β1} to R^{β8} may be independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

As described above, by using the optical recording medium, the dye compound using method, and the visible information recording method of the present invention, high-contrast, clear, visible information with excellent fastness can be recorded even in the case of using a system for recording visible information on a visible information recording layer.

### BRIEF DESCRIPTION OF THE DRAWINGS

FIG. 1 is a cross-sectional view partly showing an optical recording medium according to an embodiment of the present invention;

FIG. 2 is a cross-sectional view partly showing a visible information recording medium part in the optical recording medium according to the embodiment;

FIG. 3 is a cross-sectional view partly showing a data recording medium part in the optical recording medium according to the embodiment;

FIG. 4 is a block flow diagram of an example of a method for producing the optical recording medium according to the embodiment; and

FIG. 5 is a table showing contrast evaluation of optical recording media according to Examples 1 to 10.

### BEST MODE FOR CARRYING OUT THE INVENTION

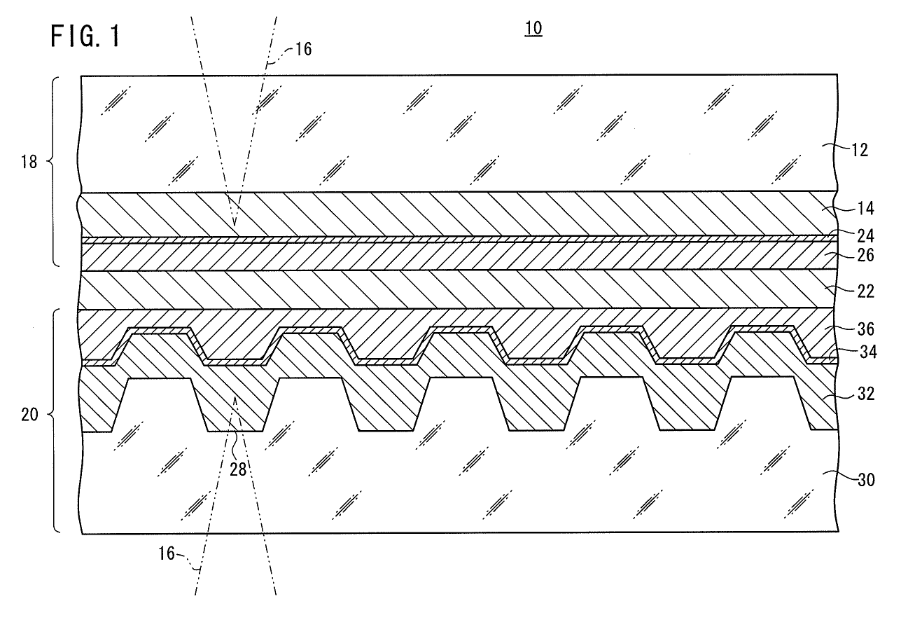

An embodiment of the optical recording medium, the dye compound use method, and the visible information recording method of the present invention will be described below with reference to FIGS. 1 to 5.

As shown in FIG. 1, an optical recording medium 10 according to this embodiment has a transparent first substrate 12 and a visible information recording layer 14 formed thereon. The visible information recording layer 14 is irradiated with a laser light 16 through the first substrate 12, whereby visible information is recorded on the visible information recording layer 14.

Specifically, as shown in FIG. 1, the optical recording medium 10 has a structure containing visible information recording medium part 18 and a data recording medium part 20 bonded with an adhesion layer 22.

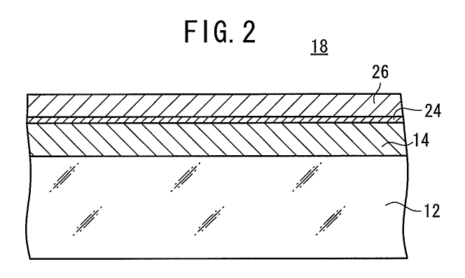

As shown in FIG. 2, the visible information recording medium part 18 contains the first substrate 12 having a flat surface. The visible information recording layer 14 is formed on the surface of the first substrate 12, a first reflective layer 24 is formed on the visible information recording layer 14, and a first protective layer 26 is formed on the first reflective layer 24.

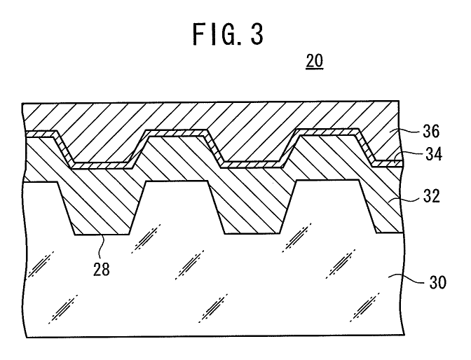

As shown in FIG. 3, the data recording medium part 20 contains a transparent second substrate 30, and pregrooves 28 are formed on a surface thereof. A data recording layer 32 is formed on the surface of the second substrate 30 along the concavities and convexities of the pregrooves 28, a second reflective layer 34 is formed on the data recording layer 32, and a second protective layer 36 is formed on the second reflective layer 34.

As shown in FIG. 1, the visible information recording medium part 18 and the data recording medium part 20 are bonded using the adhesion layer 22 therebetween such that the first protective layer 26 on the first substrate 12 faces the second protective layer 36 on the second substrate 30, whereby the optical recording medium 10 is provided.

Data (pit information) can be recorded and/or reproduced on the data recording layer 32 by irradiating the layer with a laser light 16 through the second substrate 30.

The optical recording medium 10, a method for producing the optical recording medium 10, and a method for recording visible information will be described below.

The optical recording medium 10 may be a read-only-, WORM-, or rewritable-type medium, and is preferably a WORM-type medium. The recording manner of the WORM-type medium may be selected from phase change-, magnetic optical-, and dye-type manners without particular restrictions, and is preferably dye-type.

Examples of the layer structure of the optical recording medium 10 include the following structures.

(1) A first layer structure (not shown) is such that the data recording layer 32, the second reflective layer 34, the adhesion layer 22, the first reflective layer 24, the visible information recording layer 14, and the first substrate 12 are disposed on the second substrate 30.

(2) A second layer structure (not shown) is such that the data recording layer 32, the second reflective layer 34, the adhesion layer 22, the visible information recording layer 14, and the first substrate 12 are disposed on the second substrate 30.

(3) A third layer structure (not shown) is such that the data recording layer 32, the second reflective layer 34, the second protective layer 36, the adhesion layer 22, the visible information recording layer 14, and the first substrate 12 are disposed on the second substrate 30.

(4) A fourth layer structure (not shown) is such that the data recording layer 32, the second reflective layer 34, the second protective layer 36, the adhesion layer 22, the first protective layer 26, the visible information recording layer 14, and the first substrate 12 are disposed on the second substrate 30.

(5) A fifth layer structure is equal to the structure of FIG. 1 such that the data recording layer 32, the second reflective layer 34, the second protective layer 36, the adhesion layer 22, the first protective layer 26, the first reflective layer 24, the visible information recording layer 14, and the first substrate 12 are disposed on the second substrate 30.

The layer structures of (1) to (5) are considered in all respects to be illustrative and not restrictive, and the above layers may be formed in another order and may be omitted partly. Further, each layer may have a single- or multi-layer structure.

The first substrate 12, the second substrate 30, and the layers will be described below.

### [First Substrate 12]

The first substrate 12 of the optical recording medium 10 may comprise a material appropriately selected from known materials used in conventional optical recording medium substrates.

Examples of the materials for the first substrate 12 include glasses, polycarbonates, acrylic resins such as polymethyl methacrylates, vinyl chloride resins such as polyvinyl chlorides and vinyl chloride copolymers, epoxy resins, amorphous polyolefins, and polyesters. These materials may be used in combination.

The materials may be used in the state of a film or a rigid substrate as the first substrate 12. Among the materials, the polycarbonates are preferred from the viewpoints of humidity resistance, dimensional stability, and cost.

The thickness of the first substrate 12 is preferably 0.1 to 1.2 mm, more preferably 0.2 to 1.1 mm.

An undercoat layer may be formed on the surface of the first substrate 12, on which the visible information recording layer 14 is formed, to improve flatness and adhesion and to prevent deterioration of the visible information recording layer 14.

Examples of materials of the undercoat layer include polymers such as polymethyl methacrylates, acrylic acid-methacrylic acid copolymers, styrene-maleic anhydride copolymers, polyvinyl alcohols, N-methylolacrylamides, styrene-vinyltoluene copolymers, chlorosulfonated polyethylenes, nitrocelluloses, polyvinyl chlorides, chlorinated polyolefins, polyesters, polyimides, vinyl acetate-vinyl chloride copolymers, ethylene-vinyl acetate copolymers, polyethylenes, polypropylenes, and polycarbonates, and surface modifying agents such as silane coupling agents. The undercoat layer may be formed by dissolving or dispersing the material in an appropriate solvent to prepare a coating liquid, and by applying thus-obtained coating liquid to the first substrate 12 using a coating method such as spin coating, dip coating, or extrusion coating.

The thickness of the undercoat layer is generally 0.005 to 20 μm, preferably 0.01 to 10 μm.

### [Visible Information Recording Layer 14]

As described above, the optical recording medium 10 has the visible information recording layer 14 in addition to the data recording layer 32. The visible information recording layer 14 contains a dye compound as a main component, and is preferably formed on the side opposite to the data recording layer 32 side. The term “the visible information recording layer 14 contains a dye compound as a main component” means that the mass ratio of the dye compound content (in the case of using a plurality of dye compounds, the total thereof) to the total solid content is 50% by mass or more in the visible information recording layer 14. The mass ratio of the dye compound content to the total solid content in the visible information recording layer 14 is preferably 80% by mass or more, more preferably 90% to 100% by mass.

The thickness of the visible information recording layer 14 is preferably 0.01 to 200 μm, more preferably 0.05 to 100 μm, further preferably 0.1 to 50 μm.

The thickness ratio between the visible information recording layer 14 and the data recording layer 32 (the thickness of the visible information recording layer 14/the thickness of the data recording layer 32) is preferably 1/100 to 100/1, more preferably 1/10 to 10/1.

Visible information desired by a user, such as a character, figure, or picture, is recorded on the visible information recording layer 14. For example, the visible information may contain a disc title, content information, a thumbnail of contents, a related picture, a design picture, a copyright notice, a recording date, a recording method, a recording format, etc.

The visible information recording layer 14 is not particularly limited as long as the visible information such as a character, image, or picture can be recorded thereon. A dye, which has an absorption maximum within a light wavelength range of 400 to 850 nm and has an absorbance of 0.05 or more (preferably 0.1 to 1.0) of the used laser light 16, is preferably used in the optical recording medium 10.

The visible information recording layer 14 in the optical recording medium 10 contains at least one dye compound selected from dye compounds represented by the following general formula (1), dye compounds represented by the following general formula (2), and dye compounds represented by the following general formula (3).

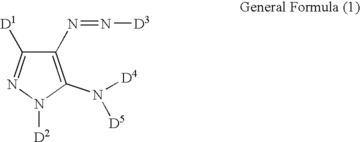

In the general formula (1), D¹ represents a hydrogen atom or a monovalent substituent, D² represents a hydrogen atom or a monovalent substituent, D³ represents an aromatic group, and D⁴ and D⁵ independently represent a hydrogen atom or a monovalent substituent. Each monovalent substituent may further have a substituent.

Specifically, in the general formula (1), D¹ may be a hydrogen atom, an alkyl group, an alkoxy group, an aryl group, an alkoxycarbonyl group, a cyano group, or a carbamoyl group, D² may be a hydrogen atom, an alkyl group, an aryl group, or a heteroaryl group, D³ may be an aryl group or a heteroaryl group, and D⁴ and D⁵ may be independently a hydrogen atom or an alkyl group.

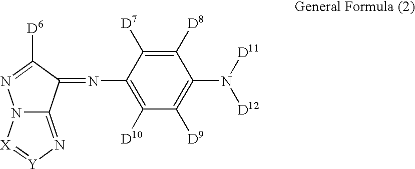

In the general formula (2), D⁶ to D¹² independently represent a hydrogen atom or a monovalent substituent. D¹¹ and D¹² may be bonded to each other to form a ring, and D⁸ and D¹¹ and/or D⁹ and D¹² may be bonded to form a ring. X and Y each represent a nitrogen atom or ═C(D¹³)- (in which D¹³ represents a hydrogen atom, an alkyl group, an aryl group, an alkoxy group, an aryloxy group, or an amino group). When both X and Y are C(D¹³)-, two D¹³'s therein may be bonded to each other to form a saturated or unsaturated carbocyclic ring. Each monovalent substituent may further have a substituent.

Specifically, in the general formula (2), it is preferred that D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and it is preferred that D¹¹ and D¹² are independently a hydrogen atom, an alkyl group, or an aryl group.

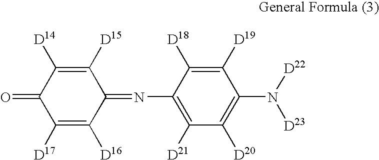

In the general formula (3), D¹⁴ to D²¹ independently represent a hydrogen atom or a monovalent substituent, and D²² and D²³ independently represent a hydrogen atom or a monovalent substituent. D²² and D²³ may be bonded to each other to form a ring, and D¹⁹ and D²² and/or D²⁰ and D²³ may be bonded to form a ring.

Specifically, in the general formula (3), it is preferred that D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and it is preferred that D²² and D²³ are independently a hydrogen atom, an alkyl group, or an aryl group.

The above groups will be described in more detail below.

Examples of halogen atoms in the general formulae (2) and (3) include fluorine, chlorine, bromine, and iodine atoms. The halogen atom is preferably a chlorine or bromine atom, particularly preferably a chlorine atom.

The alkyl groups in the general formulae (1) to (3) include substituted or unsubstituted, cycloalkyl or bicycloalkyl groups, and straight or branched, substituted or unsubstituted alkyl groups. The straight or branched, substituted or unsubstituted alkyl group preferably has 1 to 30 carbon atoms. Specific examples thereof include a methyl group, an ethyl group, a n-propyl group, an isopropyl group, a t-butyl group, a n-octyl group, an eicosyl group, a 2-chloroethyl group, a 2-cyanoethyl group, and a 2-ethylhexyl group. The substituted or unsubstituted cycloalkyl group preferably has 3 to 30 carbon atoms. Specific examples thereof include a cyclohexyl group, a cyclopentyl group, and a 4-n-dodecylcyclohexyl group. The substituted or unsubstituted bicycloalkyl group preferably has 5 to 30 carbon atoms, and thus is preferably a monovalent group provided by removing one hydrogen atom from a bicycloalkane having 5 to 30 carbon atoms. Specific examples thereof include bicyclo[1,2,2]heptane-2-yl and bicyclo[2,2,2]octane-3-yl groups. The alkyl groups further include those having more rings such as tricycloalkyl groups. Alkyl groups in the substituents to be hereinafter described (e.g. an alkyl group in an alkylthio group) have the same meanings as those described above.

The alkoxy groups in the general formulae (1) to (3) include substituted or unsubstituted alkoxy groups. The substituted or unsubstituted alkoxy group preferably has 1 to 30 carbon atoms. Examples of the alkoxy groups include a methoxy group, an ethoxy group, an isopropoxy group, a n-octyloxy group, a methoxyethoxy group, a hydroxyethoxy group, and a 3-carboxypropoxy group.

The aryl group in the general formulae (1) to (3) may be a substituted or unsubstituted aryl group having 6 to 30 carbon atoms. Specific examples thereof include a phenyl group, a p-tolyl group, a naphthyl group, a m-chlorophenyl group, and an o-hexadecanoylaminophenyl group.

The alkoxycarbonyl group in the general formulae (1) to (3) is preferably a substituted or unsubstituted alkoxycarbonyl group having 2 to 30 carbon atoms. Examples of the alkoxycarbonyl groups include a methoxycarbonyl group, an ethoxycarbonyl group, a t-butoxycarbonyl group, and a n-octadecyloxycarbonyl group.

The carbamoyl group in the general formulae (1) to (3) is preferably a substituted or unsubstituted carbamoyl group having 1 to 30 carbon atoms. Examples of the carbamoyl groups include a carbamoyl group, an N-methylcarbamoyl group, an N,N-dimethylcarbamoyl group, an N,N-di-n-octylcarbamoyl group, and an N-(methylsulfonyl)carbamoyl group.

The aryloxy group in the general formulae (2) and (3) is preferably a substituted or unsubstituted aryloxy group having 6 to 30 carbon atoms. Examples of the aryloxy groups include a phenoxy group, a 2-methylphenoxy group, a 4-t-butylphenoxy group, a 3-nitrophenoxy group, and a 2-tetradecanoylaminophenoxy group.

The acylamino group in the general formulae (2) and (3) is preferably a formylamino group, a substituted or unsubstituted alkylcarbonylamino group having 1 to 30 carbon atoms, or a substituted or unsubstituted arylcarbonylamino group having 6 to 30 carbon atoms. Examples of the acylamino groups include a formylamino group, an acetylamino group, a pivaloylamino group, a lauroylamino group, a benzoylamino group, and a 3,4,5-tri-n-octyloxyphenylcarbonylamino group.

The alkoxycarbonylamino group in the general formulae (2) and (3) is preferably a substituted or unsubstituted alkoxycarbonylamino group having 2 to 30 carbon atoms. Examples of the alkoxycarbonylamino groups include a methoxycarbonylamino group, an ethoxycarbonylamino group, a t-butoxycarbonylamino group, a n-octadecyloxycarbonylamino group, and an N-methyl-methoxycarbonylamino group.

The alkylthio group in the general formulae (2) and (3) is preferably a substituted or unsubstituted alkylthio group having 1 to 30 carbon atoms. Examples of the alkylthio groups include a methylthio group, an ethylthio group, and a n-hexadecylthio group.

The sulfamoyl group in the general formulae (2) and (3) is preferably a substituted or unsubstituted sulfamoyl group having 0 to 30 carbon atoms. Examples of the sulfamoyl groups include an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, and an N—(N′-phenylcarbamoyl)sulfamoyl group.

The acyl group in the general formulae (2) and (3) is preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclylcarbonyl group having 4 to 30 carbon atoms, in which a heterocyclyl is bonded to a carbonyl group via a carbon atom. Examples of the acyl groups include an acetyl group, a pivaloyl group, a 2-chloroacetyl group, a stearoyl group, a benzoyl group, a p-n-octyloxyphenylcarbonyl group, a 2-pyridylcarbonyl group, and a 2-furylcarbonyl group.

The amino groups in the general formulae (2) and (3) include arylamino groups. The amino group is preferably a substituted or unsubstituted alkylamino group having 1 to 30 carbon atoms, or a substituted or unsubstituted arylamino group having 6 to 30 carbon atoms. Examples of the amino groups include an amino group, a methylamino group, a dimethylamino group, an anilino group, an N-methylanilino group, a diphenylamino group, a hydroxyethylamino group, a carboxyethylamino group, a sulfoethylamino group, and a 3,5-dicarboxyanilino group.

The above described dye compounds may be used singly or in combination of two or more in the optical recording medium 10 according to this embodiment. The dye compound represented by the general formula (1) is a yellow dye compound, the dye compound represented by the general formula (2) is a magenta dye compound, and the dye compound represented by the general formula (3) is a cyan dye compound. In this embodiment, the dye compounds may be used appropriately in combination depending on a desired color tone if necessary. When the dye compound absorbs the applied laser light 16 and is decomposed by heat generated via photothermal conversion, its absorbance of a visible light can be reduced. In this case, the decomposed dye area becomes different in color tone from undecomposed colored area, whereby visible information such as an image is formed on the visible information recording layer 14.

The dye compound preferably has an absorbance of 0.5 or more (preferably 0.1 to 1.0) of a laser light 16 within a wavelength range of 400 to 850 nm. When the dye compound in the visible information recording layer 14 has such an absorbance, highly visible information such as a character, image, or picture can be recorded by the irradiation with the laser light 16.

Thus, in the present invention, there are provided at least the following first to seventh optical recording media.

### [First Optical Recording Medium]

The visible information recording layer 14 contains the dye compound represented by the general formula (1).

### [Second Optical Recording Medium]

The visible information recording layer 14 contains the dye compound represented by the general formula (2).

### [Third Optical Recording Medium]

The visible information recording layer 14 contains the dye compound represented by the general formula (3).

### [Fourth Optical Recording Medium]

The visible information recording layer 14 contains the dye compound represented by the general formula (1) and the dye compound represented by the general formula (2).

### [Fifth Optical Recording Medium]

The visible information recording layer 14 contains the dye compound represented by the general formula (1) and the dye compound represented by the general formula (3).

### [Sixth Optical Recording Medium]

The visible information recording layer 14 contains the dye compound represented by the general formula (2) and the dye compound represented by the general formula (3).

### [Seventh Optical Recording Medium]

The visible information recording layer 14 contains the dye compound represented by the general formula (1), the dye compound represented by the general formula (2), and the dye compound represented by the general formula (3).

The first to seventh optical recording media mentioned above may further contain a phthalocyanine dye represented by the following general formula (4).

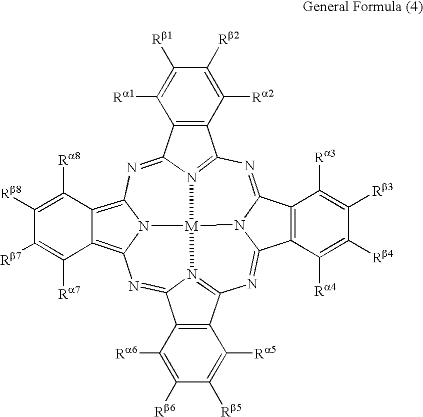

In the general formula (4), R^{α1} to R^{α8} and R^{β1} to R^{β8} independently represent a hydrogen atom or a monovalent substituent, and M represents two hydrogen atoms, a metal, a metal oxide, or a metal having a ligand.

Specifically, R^{α1} to R^{α8} and R^{β1} to R^{β8} in the general formula (4) may be independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

In the general formula (4), it is preferred that at least one of R^{α1} to R^{α8} is not a hydrogen atom, and it is further preferred that at least one of four moieties (one of R^{α1} and R^{α2}, one of R^{α3} and R^{α4}, one of R^{α5} and R^{α6}, and one of R^{α7} and R^{α8}) is not a hydrogen atom. In this case, it is particularly preferred that all R^{β1} to R^{β8} are hydrogen atoms.

In the general formula (4), each of R^{α1} to R^{α8} and R^{β1} to R^{β8} is preferably a hydrogen atom, a halogen atom, a carboxyl group, a sulfo group, an alkyl group having 1 to 16 carbon atoms, an aryl group having 6 to 10 carbon atoms, an alkoxy group having 1 to 16 carbon atoms, an aryloxy group having 6 to 10 carbon atoms, a sulfonyl group having 1 to 16 carbon atoms, a sulfamoyl group having 2 to 20 carbon atoms, an alkoxycarbonyl group having 2 to 17 carbon atoms, an aryloxycarbonyl group having 7 to 11 carbon atoms, an acylamino group having 2 to 18 carbon atoms, or a sulfonylamino group having 1 to 18 carbon atoms, more preferably a hydrogen atom, a halogen atom, a carboxyl group, a sulfo group, an alkoxy group having 1 to 16 carbon atoms, an aryloxy group having 6 to 10 carbon atoms, an alkylsulfonyl group having 1 to 14 carbon atoms, an arylsulfonyl group having 6 to 14 carbon atoms, a sulfamoyl group having 2 to 16 carbon atoms, an alkoxycarbonyl group having 2 to 13 carbon atoms, an acylamino group having 2 to 14 carbon atoms, or a sulfonylamino group having 1 to 14 carbon atoms. It is further preferred that each of R^{α1} to R^{α8} is a hydrogen atom, a halogen atom, a sulfo group, an alkoxy group having 8 to 16 carbon atoms, a sulfonyl group having 1 to 12 carbon atoms, a sulfamoyl group having 1 to 12 carbon atoms, an acylamino group having 2 to 12 carbon atoms, or a sulfonylamino group having 1 to 12 carbon atoms, and each of R^{β1} to R^{β8} is a hydrogen atom or a halogen atom. It is particularly preferred that at least one of R^{α1} to R^{α8} is a sulfo group, a sulfonyl group having 1 to 10 carbon atoms, or a sulfamoyl group having 1 to 10 carbon atoms, and R^{β1} to R^{β8} are hydrogen atoms.

In the general formula (4), R^{α1} to R^{α8} and R^{β1} to R^{β8} may have a substituent, and examples thereof include chain or cyclic alkyl groups having 1 to 20 carbon atoms, such as a methyl group, an ethyl group, an isopropyl group, and a cyclohexyl group; aryl groups having 6 to 18 carbon atoms, such as a phenyl group, a chlorophenyl group, a 2,4-di-t-amylphenyl group, and a 1-naphthyl group; aralkyl groups having 7 to 18 carbon atoms, such as a benzyl group and an anisyl group; alkenyl groups having 2 to 20 carbon atoms, such as a vinyl group and a 2-methylvinyl group; alkynyl groups having 2 to 20 carbon atoms, such as an ethynyl group, a 2-methylethynyl group, and a 2-phenylethynyl group; halogen atoms such as F, Cl, Br, and I; a cyano group; a hydroxyl group; a carboxyl group; acyl groups having 2 to 20 carbon atoms, such as an acetyl group, a benzoyl group, a salicyloyl group, and a pivaloyl group; alkoxy groups having 1 to 20 carbon atoms, such as a methoxy group, a butoxy group, and a cyclohexyloxy group; aryloxy groups having 6 to 20 carbon atoms, such as a phenoxy group, a 1-naphthoxy group, and a toluoyl group; alkylthio groups having 1 to 20 carbon atoms, such as a methylthio group, a butylthio group, a benzylthio group, and a 3-methoxypropylthio group; arylthio groups having 6 to 20 carbon atoms, such as a phenylthio group and a 4-chlorophenylthio group; alkylsulfonyl groups having 1 to 20 carbon atoms, such as a methanesulfonyl group and a butanesulfonyl group; arylsulfonyl groups having 6 to 20 carbon atoms, such as a benzenesulfonyl group and a p-toluenesulfonyl group; carbamoyl groups having 1 to 17 carbon atoms, such as an unsubstituted carbamoyl group, a methylcarbamoyl group, an ethylcarbamoyl group, a n-butylcarbamoyl group, and a dimethylcarbamoyl group; amide groups having 1 to 16 carbon atoms, such as an acetoamide group and a benzamide group; acyloxy groups having 2 to 10 carbon atoms, such as an acetoxy group and a benzoyloxy group; alkoxycarbonyl groups having 2 to 10 carbon atoms, such as a methoxycarbonyl group and an ethoxycarbonyl group; and 5- or 6-membered heterocyclic groups such as aromatic heterocyclic groups (e.g. a pyridyl group, a thienyl group, a furyl group, a thiazolyl group, an imidazolyl group, a pyrazolyl group) and heterocyclic groups (e.g. a pyrrolidine ring group, a piperidine ring group, a morpholine ring group, a pyran ring group, a thiopyran ring group, a dioxane ring group, a dithiolane ring group).

In the general formula (4), the substituent on R^{α1} to R^{α8} and R^{β1} to R^{β8} is preferably a chain or cyclic alkyl group having 1 to 16 carbon atoms, an aryl group having 6 to 14 carbon atoms, an aralkyl group having 7 to 15 carbon atoms, an alkoxy group having 1 to 16 carbon atoms, an aryloxy group having 6 to 14 carbon atoms, a halogen atom, an alkoxycarbonyl group having 2 to 17 carbon atoms, a carbamoyl group having 1 to 10 carbon atoms, or an amide group having 1 to 10 carbon atoms, more preferably a chain or cyclic alkyl group having 1 to 10 carbon atoms, an aralkyl group having 7 to 13 carbon atoms, an aryl group having 6 to 10 carbon atoms, an alkoxy group having 1 to 10 carbon atoms, an aryloxy group having 6 to 10 carbon atoms, a chlorine atom, an alkoxycarbonyl group having 2 to 11 carbon atoms, a carbamoyl group having 1 to 7 carbon atoms, or an amide group having 1 to 8 carbon atoms, particularly preferably a branched chain or cyclic alkyl group having 1 to 8 carbon atoms, an aralkyl group having 7 to 11 carbon atoms, an alkoxy group having 1 to 8 carbon atoms, an alkoxycarbonyl group having 3 to 9 carbon atoms, a phenyl group, or a chlorine atom, further preferably an alkoxy group having 1 to 6 carbon atoms.

In the general formula (4), M is preferably a metal, more preferably zinc, magnesium, copper, nickel, or palladium, further preferably copper or nickel, particularly preferably copper.

Specific examples of the phthalocyanine dye are illustrated below.

TABLE 1
Specific example of phthalocyanine dye (Part 1)

| No. | Position and type of substituent | M |
|---|---|---|
| (I-1) | R^{α1}/R^{α2}, R^{α3}/R^{α4}, R^{α5}/R^{α6}, R^{α7}/R^{α8} | Cu |
| | —SO₂N(C₅H₁₁-i)₂ | |
| (I-2) | R^{α1}/R^{α2}, R^{α3}/R^{α4}, R^{α5}/R^{α6}, R^{α7}/R^{α8} | Cu |
| | —SO₂NH(2-s-buloxy-5-t-amylphenyl) | |
| (I-3) | R^{α1}/R^{α2}, R^{α3}/R^{α4}, R^{α5}/R^{α6} | Cu |
| | —SO₂NH(CH₂)₃O(2,4-di-t-amylphcnyl) | |
| | R^{α7}/R^{α8}—SO₃H | |
| (I-4) | R^{α1}/R^{α2}, R^{α3}/R^{α4}, R^{α5}/R^{α6}, R^{α7}/R^{α8} | Ni |
| | —SO₂N(3-methoxypropyl) | |
| (I-5) | R^{α1}/R^{α2}, R^{α3}/R^{α4}, R^{α5}/R^{α6}, R^{α7}/R^{α8} | Ni |
| | —SO₂NMe(cyclohexyl) | |
| (I-6) | R^{α1}/R^{α2}, R^{α3}/R^{α4}, R^{α5}/R^{α6}, R^{α7}/R^{α8} | Ni |
| | —SO₂N(3-i-propoxyphenyl)₂ | |
| (I-7) | R^{α1}/R^{α2}, R^{α3}/R^{α4}, R^{α5}/R^{α6}, R^{α7}/R^{α8} | Pd |
| | —SO₂NH(2-i-amyloxy-carbonylphenyl) | |
| (I-8) | R^{α1}/R^{α2}, R^{α3}/R^{α4}, R^{α5}/R^{α6}, R^{α7}/R^{α8} | Pd |
| | —SO₂NH(2,4,6-trimethylphenyl) | |
| (I-9) | R^{α1}/R^{α2}, R^{α3}/R^{α4}, R^{α5}/R^{α6}, R^{α7}/R^{α8} | Co |
| | —SO₂(4-morpholino) | |
| (I-10) | R^{α1}/R^{α2}, R^{α3}/R^{α4}, R^{α5}/R^{α6}, R^{α7}/R^{α8} | Fe |
| | —SO₂N(C₂H₅)(4-fluorophenyl) | |
| (I-11) | R^{α1}/R^{α2}, R^{α3}/R^{α4}, R^{α5}/R^{α6} | Cu |
| | —SO₂NH(CH₂)₃N(C₂H₅)₂ | |
| (I-12) | R^{α1}/R^{α2}, R^{α3}/R^{α4}, R^{α5}/R^{α6}, R^{α7}/R^{α8} | Cu |
| | —SO₂(2-n-propoxyphenyl) | |
| (I-13) | R^{α1}/R^{α2}, R^{α3}/R^{α4}, R^{α5}/R^{α6}, R^{α7}/R^{α8} | Ni |
| | —SO₂(2-n-butoxy-5-t-butylphenyl) | |
| (I-14) | R^{α1}/R^{α2}, R^{α3}/R^{α4}, R^{α5}/R^{α6}, R^{α7}/R^{α8} | Co |
| | —SO₂(2-mcthoxycarbonylphenyl) | |

TABLE 2
Specific example of phthalocyanine dye (Part 2)

| No. | Position and type of substituent | M |
|---|---|---|
| (I-15) | R^{α1}/R^{α2}, R^{α3}/R^{α4}, R^{α5}/R^{α6}, R^{α7}/R^{α8} | Cu |
| | —SO₂(CH₂)₄O(2-chloro-4-t-amylphenyl) | |
| (I-16) | R^{α1}/R^{α2}, R^{α3}/R^{α4}, R^{α5}/R^{α6}, R^{α7}/R^{α8} | Pd |
| | —SO₂(CH₂)₂CO₂C₄H₉-i | |
| (I-17) | R^{α1}/R^{α2}, R^{α3}/R^{α4}, R^{α5}/R^{α6} | Cu |
| | —SO₂(cyclohexyl) | |
| (I-18) | R^{α1}/R^{α2}, R^{α3}/R^{α4}, R^{α5}/R^{α6}, R^{α7}/R^{α8} | Ni |
| | —SO₂{4-(2-s-butoxybenzoylamino)phenyl} | |
| (I-19) | R^{α1}/R^{α2}, R^{α3}/R^{α4}, R^{α5}/R^{α6} | Pd |
| | —SO₂(2,6-dichloro-4-methoxyphenyl) | |
| (I-20) | R^{α1}/R^{α2}, R^{α3}/R^{α4}, R^{α5}/R^{α6} | Mg |
| | —SO₂CH(Me)CO₂CH₂—CH(C₂H₅)C₄H₉-n | |
| (I-21) | R^{α1}/R^{α2}, R^{α3}/R^{α4}, R^{α5}/R^{α6}, R^{α7}/R^{α8} | Zn |
| | —SO₂{2-(2-ethoxyethoxy)-phenyl} | |
| | R^{β1}/R^{β2}, R^{β3}/R^{β4}, R^{β5}/R^{β6}, R^{β7}/R^{β8} | |
| | —C₂H₅ | |
| (I-22) | R^{α1}/R^{α2}, R^{α3}/R^{α4}, R^{α5}/R^{α6}, R^{α7}/R^{α8} | Cu |
| | —SO₂N(CH₂CH₂OMe)₂ | |
| (I-23) | R^{α1}/R^{α2}, R^{α3}/R^{α4}, R^{α5}/R^{α6}, R^{α7}/R^{α8} | Ni |
| | —OCH₂CH(C₂H₅)C₄H₉-n | |
| (I-24) | R^{α1}/R^{α2}, R^{α3}/R^{α4}, R^{α5}/R^{α6}, R^{α7}/R^{α8} | Zn |
| | —OCHMe(phenyl) | |
| (I-25) | R^{α1}/R^{α2}, R^{α3}/R^{α4}, R^{α5}/R^{α6}, R^{α7}/R^{α8} | Cu |
| | —OCH(s-butyl) | |
| (I-26) | R^{α1}/R^{α2}, R^{α3}/R^{α4}, R^{α5}/R^{α6}, R^{α7}/R^{α8} | SiCl₂ |
| | —OCH₂CH₂OC₃H₇-i | |
| (I-27) | R^{α1}/R^{α2}, R^{α3}/R^{α4}, R^{α5}/R^{α6}, R^{α7}/R^{α8} | Ni |
| | -t-amyl | |
| | R^{β1}/R^{β2}, R^{β3}/R^{β4}, R^{β5}/R^{β6}, R^{β7}/R^{β8} | |
| | —Cl | |

TABLE 3
Specific example of phthalocyanine dye (Part 3)

| No. | Position and type of substituent | M |
|---|---|---|
| (I-28) | R^{α1}/R^{α2}, R^{α3}/R^{α4}, R^{α5}/R^{α6}, R^{α7}/R^{α8} | Zn |
| | -(2,6-di-ethoxyphenyl) | |
| (I-29) | R^{α1}/R^{α2}, R^{α3}/R^{α4}, R^{α5}/R^{α6} | Cu |
| | —SO₂NHCH₂CH₂OC₃H₇-i | |
| | R^{α7}/R^{α8}—SO₃H | |
| (I-30) | R^{α1}/R^{α2}, R^{α3}/R^{α4}, R^{α5}/R^{α6} | Cu |
| | —CO₂CH₂CH₂OC₂H₅ | |
| | R^{α7}/R^{α8}—CO₂H | |
| (I-31) | R^{α1}/R^{α2}, R^{α3}/R^{α4}, R^{α5}/R^{α6}, R^{α7}/R^{α8} | Co |
| | —CO₂CH(Me)CO₂C₃H₇-i | |
| (I-32) | R^{α1}/R^{α2}, R^{α3}/R^{α4}, R^{α5}/R^{α6}, R^{α7}/R^{α8} | Cu |
| | —CONHCH₂CH₂OC₃H₇-i | |
| (I-33) | R^{α1}/R^{α2}, R^{α3}/R^{α4}, R^{α5}/R^{α6} | Pd |
| | —CON(CH₂CH₂OC₄H₉-n)₂ | |
| | R^{α7}/R^{α8}—CO₂H | |
| (I-34) | R^{α1}/R^{α2}, R^{α3}/R^{α4}, R^{α5}/R^{α6}, R^{α7}/R^{α8} | Co |
| | —NHCOCH(C₂H₅)C₄H₉-n | |
| (I-35) | R^{α1}/R^{α2}, R^{α3}/R^{α4}, R^{α5}/R^{α6}, R^{α7}/R^{α8} | Mg |
| | —NHCO(2-n-butoxycarbonylphenyl) | |
| (I-36) | R^{α1}/R^{α2}, R^{α3}/R^{α4}, R^{α5}/R^{α6}, R^{α7}/R^{α8} | Pd |
| | —NHSO₂(2-i-propoxyphenyl) | |
| (I-37) | R^{α1}/R^{α2}, R^{α3}/R^{α4}, R^{α5}/R^{α6}, R^{α7}/R^{α8} | Zn |
| | —NHSO₂(2-n-butoxy-5-t-amylphenyl) | |

TABLE 4
Specific example of phthalocyanine dye (Part 4)

| No. | Position and type of substituent | M |
|---|---|---|
| (I-38) | R^{α1}/R^{α2}, R^{α3}/R^{α4}, R^{α5}/R^{α6}, R^{α7}/R^{α8} | Ni |
| | —SO₂CH₃ | |
| (I-39) | R^{α1}/R^{α2}, R^{α3}/R^{α4}, R^{α5}/R^{α6}, R^{α7}/R^{α8} | Cu |
| | —SO₂CH(CH₃)₂ | |
| (I-40) | R^{α1}/R^{α2}, R^{α3}/R^{α4}, R^{α5}/R^{α6}, R^{α7}/R^{α8} | Cu |
| | —SO₂C₄H₉-s | |
| (I-41) | R^{α1}/R^{α2}, R^{α3}/R^{α4}, R^{α5}/R^{α6}, R^{α7}/R^{α8} | Zn |
| | —SO₂CH₂CO₂CH(CH₃)₂ | |
| (I-42) | R^{α1}/R^{α2}, R^{α3}/R^{α4}, R^{α5}/R^{α6}, R^{α7}/R^{α8} | Cu |
| | —SO₂CH(CH₃)CO₂CH₃ | |
| (I-43) | R^{α1}/R^{α2}, R^{α3}/R^{α4}, R^{α5}/R^{α6}, R^{α7}/R^{α8} | Cu |
| | —SO₂C₆H₅ | |
| (I-44) | R^{β1}/R^{β2}, R^{β3}/R^{β4}, R^{β5}/R^{β6}, R^{β7}/R^{β8} | Cu |
| | —SO₂N(C₅H₁₁-i)₂ | |
| (I-45) | R^{β1}/R^{β2}, R^{β3}/R^{β4}, R^{β5}/R^{β6}, R^{β7}/R^{β8} | Cu |
| | —SO₂CH(CH₃)₂ | |

The phthalocyanine derivative used in this embodiment may be synthesized by a method described or quoted in Shirai and Kobayashi, “Phthalocyanine, Kagaku to Kino (Chemistry and Function)”, p. 1 to 62, Industrial Publishing & Consulting, Inc. or C. C. Leznoff and A. B. P. Lever, “Phthalocyanines, Properties and Applications”, p. 1 to 54, VCH, or a similar method.

Specific examples of the dye compounds represented by the general formulae (1) to (3) will be described below.

Specific examples (Y-1) to (Y-10) of the dye compounds represented by the general formula (1) are illustrated below. The dye compound used in the present invention is not limited to the specific examples (Y-1) to (Y-10).

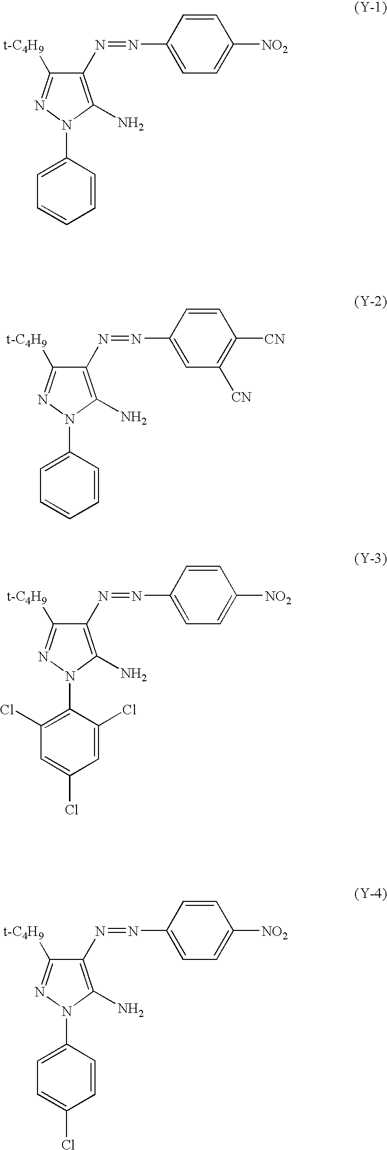

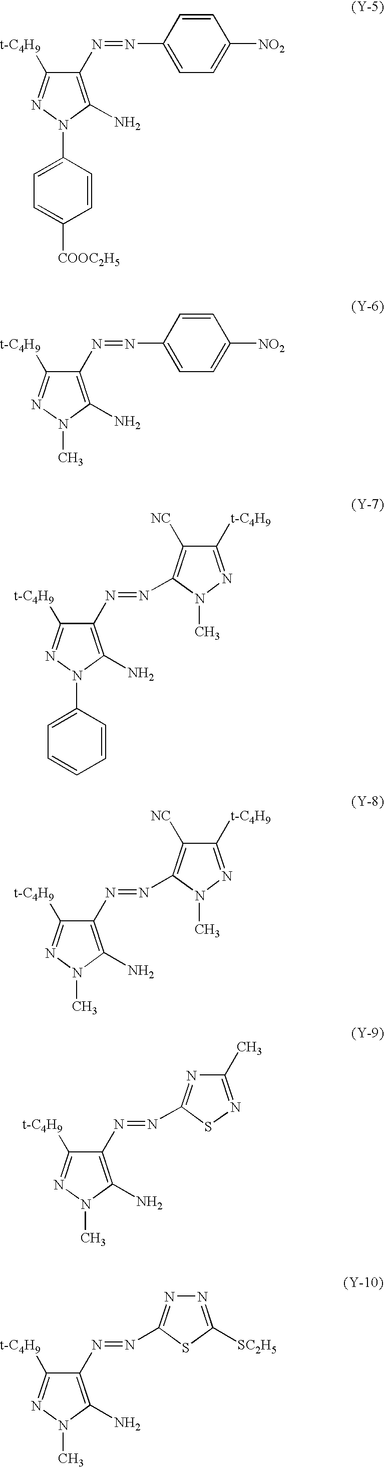

Specific examples (M-1) to (M-7) of the dye compounds represented by the general formula (2) are illustrated below. The dye compound used in the present invention is not limited to the specific examples (M-1) to (M-7).

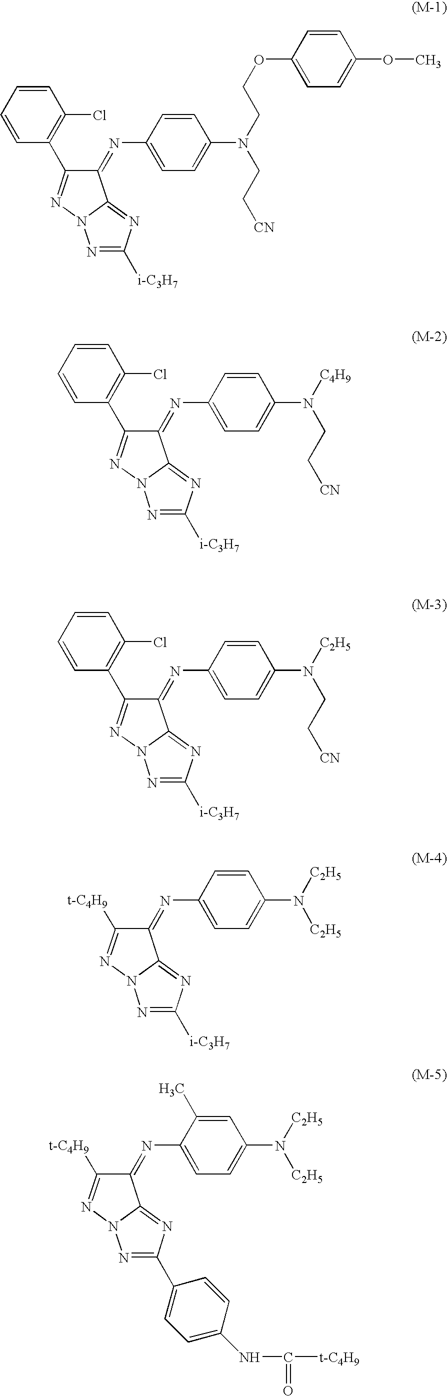

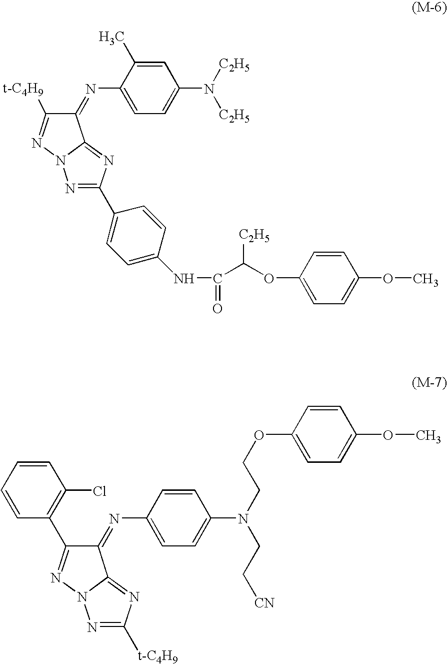

Specific examples (C-1) to (C-9) of the dye compounds represented by the general formula (3) are illustrated below. The dye compound used in the present invention is not limited to the specific examples (C-1) to (C-9).

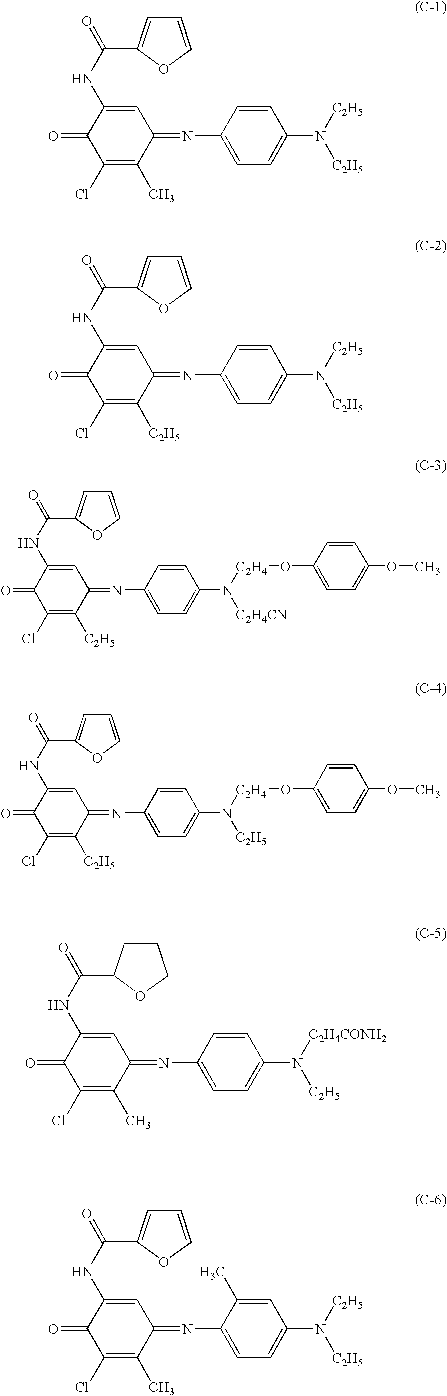

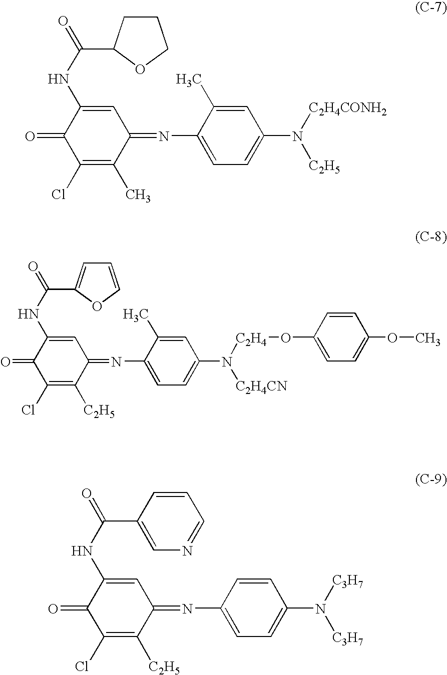

Some of the dye compounds represented by the formulae (Y-1) to (Y-7), (M-1) to (M-7), and (C-1) to (C-9) are commercially available. Commercially unavailable ones of the dye compounds can be synthesized in accordance with a method described in U.S. application Ser. No. 07/059,442, U.S. Pat. No. 3,770,370, Japanese Laid-Open Patent Publication No. 2004-51873, German Patent No. 2316755, Japanese Laid-Open Patent Publication Nos. 7-137455 and 61-31292, J. Chem. Soc. Perkin transfer I, 1977, 2047, and Champan, “Merocyanine Dye-Doner Element Used in thermal Dye Transefer”.

The optical recording medium 10 is not particularly limited as long as it contains the above-mentioned dye compound in the visible information recording layer 14 (preferably also in the data recording layer 32). In a case where the optical recording medium 10 is used in a CD-R, it is preferred that the second substrate 30 has a disc shape having a thickness of 1.2±0.2 mm and the pregrooves 28 with a track pitch of 1.4 to 1.8 μm (see FIG. 1), and the data recording layer 32 containing the dye compound, the second reflective layer 34, the second protective layer 36, the adhesion layer 22, the first protective layer 26, the first reflective layer 24, the visible information recording layer 14 containing the dye compound, and the first substrate 12 are arranged in this order on the second substrate 30. In a case where the optical recording medium 10 is used in a DVD-R, it preferably has one of the following two structures.

(1) The second substrate 30 has a disc shape having a thickness of 0.6±0.1 mm and the pregrooves 28 with a track pitch of 0.6 to 0.9 μm, two stacks each are prepared by forming the data recording layer 32 containing the dye compound and a light reflective layer on the second substrate 30, the data recording layers 32 of the two stacks are bonded into a thickness of 1.2±0.2 mm, and the visible information recording layer 14 and the first substrate 12 are formed on at least one of the second substrate 30.

(2) The second substrate 30 has a disc shape having a thickness of 0.6±0.1 mm and the pregrooves 28 with a track pitch of 0.6 to 0.9 μm, a stack is prepared by forming the data recording layer 32 containing the dye compound and a light reflective layer on the second substrate 30, the data recording layer 32 of the stack is bonded to a transparent protective substrate having the same disc shape as the second substrate 30 into a thickness of 1.2±0.2 mm, and the visible information recording layer 14 and the first substrate 12 are formed on at least one of the substrates.

In the DVD-R-type optical recording medium, a protective layer may be formed on the light reflective layer.

The visible information recorded on the visible information recording layer 14 is an image that can be visually detected, and may contain any visible information such as a character (text), picture, or figure. Further, the visible information may contain character information such as accessible person designation information, accessible period designation information, accessible number designation information, rental information, resolution designation information, layer designation information, user designation information, copyright holder information, copyright number information, manufacturer information, manufacturing date information, sale date information, vendor or seller information, set number information, regional designation information, language designation information, use designation information, user information, or use number information.

The visible information recording layer 14 may be formed by dissolving the dye compound in a solvent, and by applying the obtained coating liquid. The solvent may be the same as that of the coating liquid for a data recording layer 32 to be hereinafter described. Additives and application methods for the visible information recording layer 14 may be the same as those for the data recording layer 32.

### [Data Recording Layer 32]

The data recording layer 32 is a layer on which information can be recorded by the irradiation with the laser light 16. Code information such as digital information is recorded on the data recording layer 32. The data recording layer 32 may be a WORM layer (preferably a dye WORM layer), a phase change layer, a magnetic optical layer, etc., and is preferably a dye layer, though not particularly restrictive.

Specific examples of dyes used in the dye-type data recording layer 32 include cyanine dyes, oxonol dyes, metal complex dyes, azo dyes, and phthalocyanine dyes. Dyes described in Japanese Laid-Open Patent Publication Nos. 4-74690, 8-127174, 11-53758, 11-334204, 11-334205, 11-334206, 11-334207, 2000-43423, 2000-108513, and 2000-158818, etc. can be suitably used in the data recording layer 32.

The data recording layer 32 may be formed by the steps of dissolving a binder, etc. and a recording substance such as the dye in an appropriate solvent to prepare a coating liquid, applying the coating liquid to the second substrate 30, and drying the applied liquid. The concentration of the recording substance in the coating liquid is generally 0.01% to 15% by mass, preferably 0.1% to 10% by mass, more preferably 0.5% to 5% by mass, most preferably 0.5% to 3% by mass.

The data recording layer 32 may be formed by vapor deposition, sputtering, CVD, liquid coating, etc., and is preferably formed by liquid coating. In the liquid coating, a quencher, a binder, or the like is dissolved in the solvent together with the dye, etc. if necessary, the obtained coating liquid is applied to the second substrate 30, and the applied liquid is dried to obtain the data recording layer 32.

Examples of the solvents for the coating liquid include esters such as butyl acetate, ethyl lactate, and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as dibutyl ether, diethyl ether, tetrahydrofuran, and dioxane; alcohols such as ethanol, n-propanol, isopropanol, n-butanol, and diacetone alcohol; fluorine-containing solvents such as 2,2,3,3-tetrafluoropropanol; and glycol ethers such as ethylene glycol monomethyl ether, ethylene glycol monoethyl ether, and propylene glycol monomethyl ether.

These solvents may be used singly or in combination depending on the solubility of the dye. Various additives such as antioxidants, UV absorbers, plasticizers, and lubricants may be added to the coating liquid if necessary.

Examples of the binders include natural organic high-molecular substances such as gelatins, cellulose derivatives, dextrans, rosins, and rubbers, and synthetic organic high-molecular substances. The synthetic organic high-molecular substances include hydrocarbon resins such as polyethylenes, polypropylenes, polystyrenes, and polyisobutylenes; vinyl resins such as polyvinyl chlorides, polyvinylidene chlorides, and vinyl chloride-vinyl acetate copolymers; acrylic resins such as polymethyl acrylates and polymethyl methacrylates; and initial condensation products of thermosetting resins such as polyvinyl alcohols, chlorinated polyethylenes, epoxy resins, butyral resins, rubber derivatives, and phenol-formaldehyde resins.

In the case of using the binder in the data recording layer 32, the mass of the binder is generally 0.01 to 50 times the dye, preferably 0.1 to 5 times the dye.

The coating liquid may be applied by a spraying method, a spin coating method, a dipping method, a roll coating method, a blade coating method, a doctor roll method, a screen printing method, etc. The data recording layer 32 may have a single- or multi-layer structure. The thickness of the data recording layer 32 is generally 10 to 500 nm, preferably 15 to 300 nm, more preferably 20 to 150 nm.

An anti-fading agent may be added to the data recording layer 32 to increase the light fastness. In general, the anti-fading agent is a singlet oxygen quencher. The singlet oxygen quencher may be selected from known ones described in publications such as patent publications. The ratio of the anti-fading agent such as the singlet oxygen quencher to the dye is generally 0.1% to 50% by mass, preferably 0.5% to 45% by mass, further preferably 3% to 40% by mass, particularly preferably 5% to 25% by mass.

Specific examples of the components of the phase change-type data recording layer 32 include Sb—Te alloys, Ge—Sb—Te alloys, Pd—Ge—Sb—Te alloys, Nb—Ge—Sb—Te alloys, Pd—Nb—Ge—Sb—Te alloys, Pt—Ge—Sb—Te alloys, Co—Ge—Sb—Te alloys, In—Sb—Te alloys, Ag—In—Sb—Te alloys, Ag—V—In—Sb—Te alloys, and Ag—Ge—In—Sb—Te alloys. The thickness of the phase change-type data recording layer 32 is preferably 10 to 50 nm, more preferably 15 to 30 nm. The phase change-type data recording layer 32 may be formed by a gas-phase film deposition method such as a sputtering method or a vacuum vapor deposition method.

### [Second Substrate 30]

The second substrate 30 may comprise a material selected from known materials for conventional optical recording medium substrates.

Examples of the materials for the second substrate 30 include glasses, polycarbonates, acrylic resins such as polymethyl methacrylates, vinyl chloride resins such as polyvinyl chlorides and vinyl chloride copolymers, epoxy resins, amorphous polyolefins, and polyesters. These materials may be used in combination. The materials may be used in the state of a film or a rigid substrate as the second substrate 30. Among the materials, the polycarbonates are preferred from the viewpoints of humidity resistance, dimensional stability, and cost.

The thickness of the first substrate 30 is preferably 0.1 to 1.2 mm, more preferably 0.2 to 1.1 mm.

An undercoat layer may be formed on the surface of the second substrate 30, on which the data recording layer 32 is formed (the pregrooves 28 are formed), to improve flatness and adhesion and to prevent deterioration of the data recording layer 32.

Examples of materials of the undercoat layer include polymers such as polymethyl methacrylates, acrylic acid-methacrylic acid copolymers, styrene-maleic anhydride copolymers, polyvinyl alcohols, N-methylolacrylamides, styrene-vinyltoluene copolymers, chlorosulfonated polyethylenes, nitrocelluloses, polyvinyl chlorides, chlorinated polyolefins, polyesters, polyimides, vinyl acetate-vinyl chloride copolymers, ethylene-vinyl acetate copolymers, polyethylenes, polypropylenes, and polycarbonates, and surface modifying agents such as silane coupling agents. The undercoat layer may be formed by dissolving or dispersing the material in an appropriate solvent, and by applying thus-obtained coating liquid to the second substrate 30 by a coating method such as spin coating, dip coating, or extrusion coating.

The thickness of the undercoat layer is generally 0.005 to 20 μm, preferably 0.01 to 10 μm.

### [First Reflective Layer 24 and Second Reflective Layer 34]

The first reflective layer 24 may be formed on the visible information recording layer 14, and the second reflective layer 34 may be formed on the data recording layer 32, to increase the reflectance in information reproduction.

The first reflective layer 24 and the second reflective layer 34 may comprise a light reflective substance having a high reflectance to the laser light 16. Examples of the light reflective substances include metals and metalloids of Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, Bi, etc., and stainless steels. These substances may be used singly or in combination, or as an alloy.

For example, the first reflective layer 24 may be formed on the visible information recording layer 14 by vapor-depositing, sputtering, or ion-plating the light reflective substance. Also the second reflective layer 34 may be formed on the data recording layer 32 by vapor-depositing, sputtering, or ion-plating the light reflective substance. The thickness of each of the first reflective layer 24 and the second reflective layer 34 is generally 10 to 300 nm, preferably 50 to 200 nm.

### [Adhesion Layer 22]

The adhesion layer 22 is formed to improve the adhesion between the data recording medium part 18 and the visible information recording medium part 20.

The adhesion layer 22 is preferably composed of a light curing resin. It is preferred that the light curing resin has a small cure shrinkage ratio from the viewpoint of preventing warping of the optical recording medium 10. Examples of such light curing resins include UV curing resins (UV curing adhesives) such as SD-640 and SD-347 available from Dainippon Ink and Chemicals, Inc. The thickness of the adhesion layer 22 is preferably 1 to 1,000 am, more preferably 5 to 500 μm, particularly preferably 10 to 100 μm, in view of flexibility.

### [First Protective Layer 26 and Second Protective Layer 36]

The first protective layer 26 may be formed to physically and chemically protect the first reflective layer 24 or the visible information recording layer 14, and the second protective layer 36 may be formed to physically and chemically protect the second reflective layer 34 or the data recording layer 32.

It is not always necessary to form the first protective layer 26 and the second protective layer 36 in the case of using the structure of the DVD-R optical recording medium, thus bonding two substrates (one may be the transparent substrate 24), two data recording layers 32 facing inward.

Examples of materials for the first protective layer 26 and the second protective layer 36 include inorganic substances such as ZnS, ZnS—SiO₂, SiO, SiO₂, MgF₂, SnO₂, and Si₃N₄, and organic substances such as thermoplastic resins, thermosetting resins, and UV curing resins.

In the case of using the thermoplastic or thermosetting resin, the protective layer may be formed by the steps of dissolving the resin in an appropriate solvent, applying the obtained coating liquid, and drying the applied liquid. In the case of using the UV curing resin, the protective layer may be formed by the steps of applying the UV curing resin or a coating liquid containing the UV curing resin and an appropriate solvent, and irradiating the applied UV curing resin with a UV light to harden the UV curing resin. Various additives such as antistatic-agents, antioxidants, and UV absorbers may be added to the coating liquids in accordance with the purpose. The protective layer generally has a thickness of 0.1 μm to 1 mm.

As described above, the optical recording medium 10 can be used as a so-called read-only medium having a recording part (a pit), on which reproducible information is recorded by the laser light 16.

Thus, in the optical recording medium 10 according to this embodiment, the visible information recording layer 14 contains at least one of the dye compounds represented by the general formula (1), dye compounds represented by the general formula (2), dye compounds represented by the general formula (3). As a result, the optical recording medium 10 is capable of recording high-contrast, clear, visible information with excellent fastness, even in the case of using a system for recording visible information on the visible information recording layer 14 (e.g. a system described in Japanese Laid-Open Patent Publication No. 2002-203321).

### [Method for Producing Optical Information Recording Medium 10]

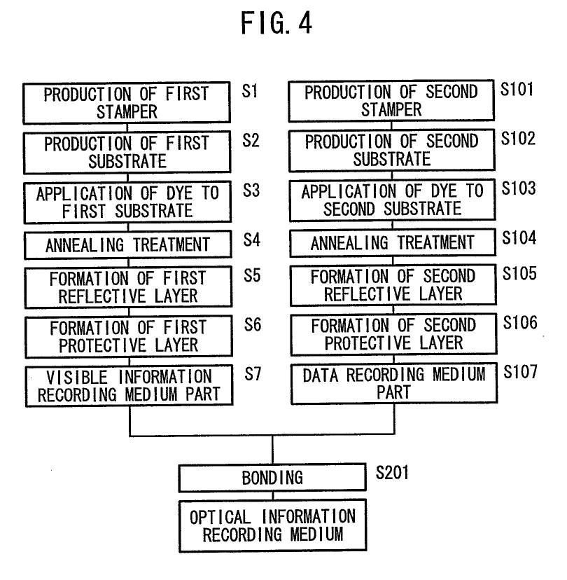

A method for producing the optical information recording medium 10 according to this embodiment will be described below with reference to FIG. 4.

First, in the step S1 of FIG. 4, a first stamper for producing the first substrate 12 is produced. The first stamper is produced such that, when the first substrate 12 of a resin or the like is injection-formed using the first stamper, the resultant first substrate 12 has a flat surface.

Then, in the step S2 of FIG. 4, a resin such as a polycarbonate, etc. is injected onto the first stamper, to produce the first substrate 12. The obtained first substrate 12 has a flat surface (see FIG. 2).

In the step S3 of FIG. 4, the first substrate 12 is cooled, and a dye for forming the visible information recording layer 14 is applied to a surface of the first substrate 12. For example, a coating liquid containing the dye (a dye coating liquid) is prepared, and is applied by a spin coating method to the flat surface of the first substrate 12.

In the step S4 of FIG. 4, an annealing treatment is carried out to dry the dye coating liquid. For example, the annealing treatment is carried out at 80° C. for 3 hours. The dye coating liquid is converted to the visible information recording layer 14 by the annealing treatment.

In the step S5 of FIG. 4, the first reflective layer 24 is formed on the surface of the visible information recording layer 14 by a sputtering method, etc.

In the step S6 of FIG. 4, the first protective layer 26 is formed on the surface of the first reflective layer 24. For example, the first protective layer 26 may be formed by the steps of dissolving a UV curing resin in an appropriate solvent, applying the obtained coating liquid, and irradiating the applied UV curing resin with a UV light to harden the UV curing resin. Production of the visible information recording medium part 18 is completed at this stage.

Meanwhile, in the step S101 of FIG. 4, a second stamper for producing the second substrate 30 is produced. In this step, an original plate for the second stamper is selectively etched to obtain the second stamper with surface concavities and convexities. For example, the original plate is subjected to high accuracy mastering using cutting with a DUV (deep ultraviolet with a wavelength of 330 nm or less) laser, an EB (electron beam), etc.

In this step, the original plate is subjected to the mastering such that, when the second substrate 30 of a resin or the like is injection- or extrusion-formed using the second stamper, the resultant second substrate 30 has a surface having the pregrooves 28.

In the step S102 of FIG. 4, for example, a resin such as a polycarbonate, etc. is injected onto the second stamper, to produce the second substrate 30. The concavities and convexities of the second stamper are transferred to a surface of the second substrate 30, whereby the pregrooves 28 are formed.

Though the second substrate 30 is produced by injection- or extrusion-forming a resin such as a polycarbonate in this example, it may be produced by disposing a pregrooved layer on a flat surface of the second substrate 30 to form the pregrooves 28.

The material for the pregrooved layer may be a mixture of a photopolymerization initiator and at least one monomer (or oligomer) selected from monoesters, diesters, triesters, and tetraesters of acrylic acid. For example, the second substrate 30, to which the pregrooved layer with the pregrooves 28 is attached, can be obtained by the steps of applying the mixture of the acrylic ester and the polymerization initiator to the second stamper, placing the second substrate 30 on the applied liquid layer, irradiating the applied layer with an ultraviolet light through the second substrate 30 or the second stamper, thereby hardening the applied layer to bond the second substrate 30 and the layer, and removing the second stamper from the second substrate 30.

Then, in the step S103 of FIG. 4, the second substrate 30 is cooled, and a dye for forming the data recording layer 32 is applied to a surface of the second substrate 30. For example, a coating liquid containing the dye (a dye coating liquid) is prepared, and is applied by a spin coating method to the surface having the pregrooves 28 of the second substrate 30.

In the step S104 of FIG. 4, an annealing treatment is carried out to dry the dye coating liquid. For example, the annealing treatment is carried out at 80° C. for 3 hours. The dye coating liquid is converted to the data recording layer 32 by the annealing treatment.

In the step S105 of FIG. 4, the second reflective layer 34 is formed on the surface of the data recording layer 32 by a sputtering method, etc.

In the step S106 of FIG. 4, the second protective layer 36 is formed on the surface of the second reflective layer 34. For example, the second protective layer 36 may be formed by the steps of dissolving a UV curing resin in an appropriate solvent, applying the obtained coating liquid, and irradiating the applied UV curing resin with a UV light to harden the UV curing resin. Production of the data recording medium part 20 is completed at this stage.

Then, in the step S201 of FIG. 4, the visible information recording medium part 18 is bonded to the data recording medium part 20. In this step, the visible information recording medium part 18 and the data recording medium part 20 are bonded using the adhesion layer 22 therebetween, the first protective layer 26 on the visible information recording medium part 18 facing the second protective layer 36 on the data recording medium part 20. Production of the optical recording medium 10 is completed by this bonding step.

### [Visible Information Recording Method]

In a visible information recording method according to this embodiment, visible information is recorded on the visible information recording layer 14 of the optical recording medium 10. It is preferred that the laser light 16 for recording the visible information on the visible information recording layer 14 is equal to that for recording on the data recording layer 32 (see FIG. 1).

In this visible information recording method, the optical recording medium 10 is used in a recording apparatus to be hereinafter described, capable of recording the visible information at least on the visible information recording layer 14.

In the visible information recording method, because the visible information can be recorded on the visible information recording layer 14 by using the laser light 16 equal to that for recording data on the data recording layer 32, the visible information and the data can be recorded by only one common laser light source in the recording apparatus, so that hardware resources of the recording apparatus can be minimized and general users can easily record the visible information using the apparatus.

It is most preferred that the visible information is recorded on the visible information recording layer 14 of the optical recording medium 10 by this visible information recording method, though not restrictive.

### [Recording Apparatus]

The recording apparatus for recording information on the optical information recording medium 10 will be described below.

In the optical recording medium 10, the recording of the visible information on the visible information recording layer 14 and the recording of the data (pit information) on the data recording layer 32 can be carried out using only one optical disc drive (recording apparatus). In the case of using the one optical disc drive, the recording on one of the visible information recording layer 14 and the data recording layer 32 may be carried out first, and then the optical recording medium 10 may be reversed to achieve the recording on the other layer. The optical disc drive capable of recording the visible information on the visible information recording layer 14 is described in Japanese Laid-Open Patent Publication Nos. 2003-203348 and 2003-242750, etc., and thus detailed explanations therefor are omitted.

The visible information may be recorded on the visible information recording layer 14 such that a laser pickup is relatively moved along the surface of the optical recording medium 10 in the recording apparatus, and the laser light 16 is modulated synchronously with the relative movement in accordance with an image data of a character, a picture, etc. to be displayed, and is applied to the visible information recording layer 14. Thus, the visible information is recorded on the visible information recording layer 14 by applying the laser light 16 to the visible information recording layer 14 repeatedly in an approximately same trajectory pattern while oscillating (vibrating) the laser light 16 in the radial direction of the optical recording medium 10. Such a system is described in Japanese Laid-Open Patent Publication No. 2002-203321, etc., and thus detailed explanations therefor are omitted.

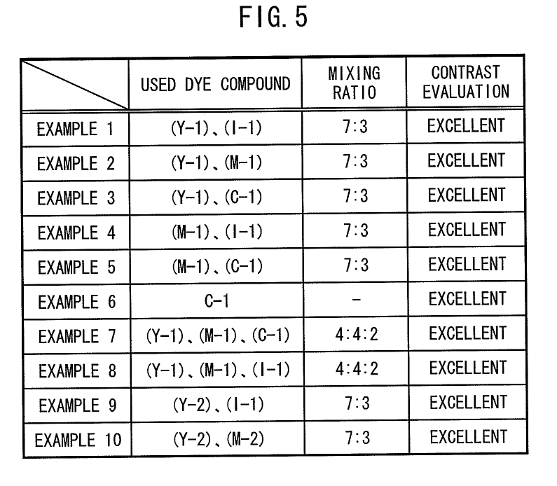

Contrast evaluation of optical recording media according to Examples 1 to 10 will be described below with reference to FIG. 5. The optical recording medium 10 of this embodiment is not limited to the media of Examples 1 to 10.

### Example 1

An optical recording medium according to Example 1 is a DVD-R-type optical recording medium or the like having the same layer structure as the optical recording medium 10 of the embodiment shown in FIG. 1. A method for producing the optical recording medium of Example 1 is described below.

First, 1.0 g of a mixture of the dye compound (Y-1) and the phthalocyanine dye (I-1) was dissolved in 100 ml of 2,2,3,3-tetrafluoro-1-propanol to prepare a visible information recording layer coating liquid for forming a visible information recording layer 14. The visible information recording layer coating liquid was applied by a spin coating method to a first substrate 26 having a thickness of 0.6 mm and a diameter of 120 mm. The mixing ratio between the dye compound (Y-1) and the phthalocyanine dye (I-1) was 7:3.

Silver was sputtered on the visible information recording layer 14 to form a first reflective layer 24 having a thickness of 120 nm. A UV curing resin SD318 available from Dainippon Ink and Chemicals, Inc. was applied by a spin coating method to the first reflective layer 24, and hardened by irradiation with an ultraviolet light to form a first protective layer having a thickness of 10 μm. A visible information recording medium part was produced by the above steps.

Then, a polycarbonate resin was injection-formed into a second substrate 16 having a thickness of 0.6 mm, a diameter of 120 mm, and spiral grooves (depth 130 nm, width 300 nm, track pitch 0.74 μm).

The following two oxonol dyes were each dissolved in an amount of 1.5 g in 100 ml of 2,2,3,3-tetrafluoro-1-propanol, and the obtained coating liquid was applied by a spin coating method to a surface having the pregrooves 28 of the first substrate 16, to form a recording layer 18.

### (Two Oxonol Dyes)

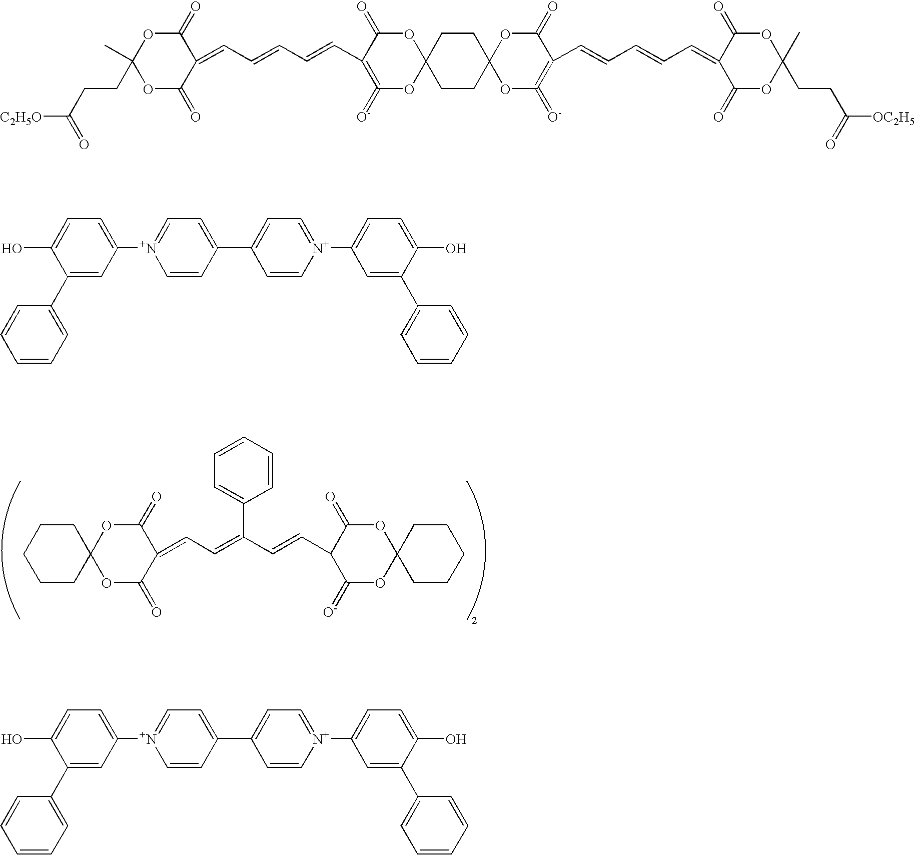

Silver was sputtered on the data recording layer 18 to form a second reflective layer 20 having a thickness of 120 nm. A UV curing resin SD318 available from Dainippon Ink and Chemicals, Inc. was applied by a spin coating method to the second reflective layer 20, and hardened by irradiation with an ultraviolet light to form a second protective layer having a thickness of 10 μm. A data recording medium part was produced by the above steps.

Then, the visible information recording medium part and the data recording medium part were bonded to complete a plate of the optical recording medium as follows. First a slow-setting, cationic polymerization-type adhesive SDK7000 available from Sony Chemical Corporation was screen-printed on the first protective layer of the visible information recording medium part and the second protective layer of the data recording medium part. In this step, a printing plate having a mesh size of 300 mesh was used in the screen printing. Immediately after the resultant was irradiated with an ultraviolet light using a metal halide lamp, the protective layers of the visible information recording medium part and the data recording medium part were bonded. Both sides of the resulting stack were pressed and left for 5 minutes to produce the optical recording medium of Example 1.

### Example 2

Example 2 was the same as Example 1 except that 1.0 g of a mixture of the dye compound (Y-1) and the dye compound (M-1) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-1) and the dye compound (M-1) was 7:3.

### Example 3

Example 3 was the same as Example 1 except that 1.0 g of a mixture of the dye compound (Y-1) and the dye compound (C-1) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-1) and the dye compound (C-1) was 7:3.

### Example 4

Example 4 was the same as Example 1 except that 1.0 g of a mixture of the dye compound (M-1) and the phthalocyanine dye (I-1) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-1) and the phthalocyanine dye (I-1) was 7:3.

### Example 5

Example 5 was the same as Example 1 except that 1.0 g of a mixture of the dye compound (M-1) and the dye compound (C-1) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (M-1) and the dye compound (C-1) was 7:3.

### Example 6

Example 6 was the same as Example 1 except that 1.0 g of the dye compound (C-1) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer.

### Example 7

Example 7 was the same as Example 1 except that 1.0 g of a mixture of the dye compound (Y-1), the dye compound (M-1), and the dye compound (C-1) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-1), the dye compound (M-1), and the dye compound (C-1) was 4:4:2.

### Example 8

Example 8 was the same as Example 1 except that 1.0 g of a mixture of the dye compound (Y-1), the dye compound (M-1), and the phthalocyanine dye was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-1), the dye compound (M-1), and the phthalocyanine dye (I-1) was 4:4:2.

### Example 9

Example 9 was the same as Example 1 except that 1.0 g of a mixture of the dye compound (Y-2) and the phthalocyanine dye was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-2) and the phthalocyanine dye (I-1) was 7:3.

### Example 10

Example 10 was the same as Example 1 except that 1.0 g of a mixture of the dye compound (Y-2) and the dye compound (M-2) was dissolved in 100 ml of 2,2,3,3-tetrafluoro-1-propanol, and thus obtained visible information recording layer coating liquid was applied by a spin coating method to a first substrate 26 having a thickness of 0.6 mm and a diameter of 120 mm to form a visible information recording layer. The mixing ratio between the dye compound (Y-2) and the dye compound (M-2) was 7:3.

### (Contrast Evaluation)

Visible information was recorded at a DVD-R recording/reproducing wavelength (660 nm) on the visible information recording layer 14 in each of the produced optical recording media of Examples 1 to 10, and the contrast was evaluated.

The visible information was recorded by a focused semiconductor laser having the DVD-R recording/reproducing wavelength of 660 nm, under a linear speed of 3.5 m/s and a power of 8 mW, while mechanically moving the pickup.

As a result, in all the optical recording media, high-contrast, clear, visible information could be recorded on the visible information recording layer.

It should be understood that the optical recording medium, the dye compound use method, and the visible information recording method of the present invention are not limited to the above embodiment, and various changes and modifications may be made therein without departing from the scope of the invention.

1. An optical recording medium comprising a substrate and a visible information recording layer formed thereon, visible information being recorded on the visible information recording layer by applying a laser light to the visible information recording layer repeatedly in an approximately same trajectory pattern while oscillating the laser light in a radial direction of the substrate, wherein
the visible information recording layer comprises at least one dye compound selected from
dye compounds represented by the following general formula (1): 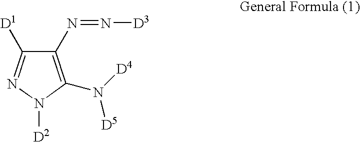
wherein D¹ represents a hydrogen atom or a monovalent substituent, D² represents a hydrogen atom or a monovalent substituent, D³ represents an aromatic group, D⁴ and D⁵ independently represent a hydrogen atom or a monovalent substituent, and the monovalent substituent may further have a substituent,
dye compounds represented by the following general formula (2): 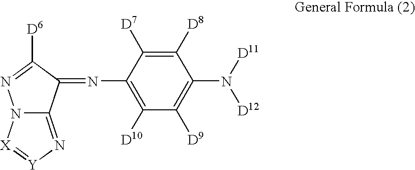
wherein D⁶ to D¹² independently represent a hydrogen atom or a monovalent substituent, D¹¹ and D¹² may be bonded to each other to form a ring, D⁸ and D¹¹ and/or D⁹ and D¹² may be bonded to form a ring, X and Y each represent a nitrogen atom or ═C(D¹³)- (in which D¹³ represents a hydrogen atom, an alkyl group, an aryl group, an alkoxy group, an aryloxy group, or an amino group), when both X and Y are C(D¹³)- two D¹³'s in X and Y may be bonded to each other to form a saturated or unsaturated carbocyclic ring, and the monovalent substituent may further have a substituent, and
dye compounds represented by the following general formula (3): 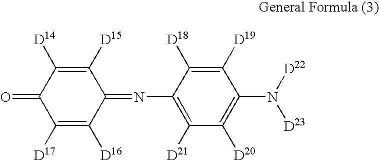
wherein D¹⁴ to D²¹ independently represent a hydrogen atom or a monovalent substituent, D²² and D²³ independently represent a hydrogen atom or a monovalent substituent, D²² and D²³ may be bonded to each other to form a ring, and D¹⁹ and D²² and/or D²⁰ and D²³ may be bonded to form a ring.

2. An optical recording medium according to claim 1, wherein
in the general formula (1), D¹ is a hydrogen atom, an alkyl group, an alkoxy group, an aryl group, an alkoxycarbonyl group, a cyano group, or a carbamoyl group, D² is a hydrogen atom, an alkyl group, an aryl group, or a heteroaryl group, D³ is an aryl group or a heteroaryl group, and D⁴ and D⁵ are independently a hydrogen atom or an alkyl group,
in the general formula (2), D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D¹¹ and D¹² are independently a hydrogen atom, an alkyl group, or an aryl group, and
in the general formula (3), D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D²² and D²³ are independently a hydrogen atom, an alkyl group, or an aryl group.

3. An optical recording medium according to claim 1, further comprising a phthalocyanine dye represented by the following general formula (4): 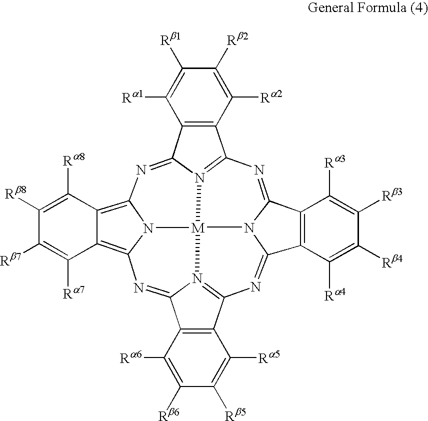
wherein R^{α1} to R^{α8} and R^{β1} to R^{β8} independently represent a hydrogen atom or a monovalent substituent, and M represents two hydrogen atoms, a metal, a metal oxide, or a metal having a ligand.

4. An optical recording medium according to claim 3, wherein R^{α1} to R^{α8} and R^{β1} to R^{β8} in the general formula (4) are independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

5. An optical recording medium comprising a substrate and a visible information recording layer formed thereon, wherein
the visible information recording layer comprises at least one dye compound selected from
dye compounds represented by the following general formula (1): 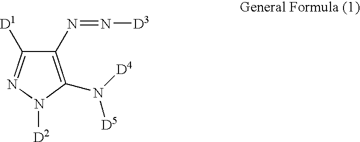
wherein D¹ represents a hydrogen atom or a monovalent substituent, D² represents a hydrogen atom or a monovalent substituent, D³ represents an aromatic group, D⁴ and D⁵ independently represent a hydrogen atom or a monovalent substituent, and the monovalent substituent may further have a substituent,
dye compounds represented by the following general formula (2): 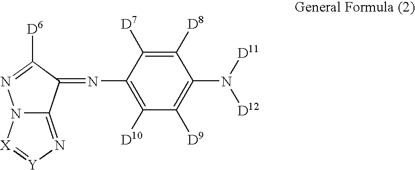
wherein D⁶ to D¹² independently represent a hydrogen atom or a monovalent substituent, D¹¹ and D¹² may be bonded to each other to form a ring, D⁸ and D¹¹ and/or D⁹ and D¹² may be bonded to form a ring, X and Y each represent a nitrogen atom or ═C(D¹³)- (in which D¹³ represents a hydrogen atom, an alkyl group, an aryl group, an alkoxy group, an aryloxy group, or an amino group), when both X and Y are C(D¹³)- two D¹³'s in X and Y may be bonded to each other to form a saturated or unsaturated carbocyclic ring, and the monovalent substituent may further have a substituent, and
dye compounds represented by the following general formula (3): 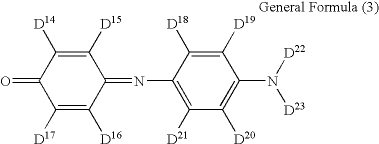
wherein D¹⁴ to D²¹ independently represent a hydrogen atom or a monovalent substituent, D²² and D²³ independently represent a hydrogen atom or a monovalent substituent, D²² and D²³ may be bonded to each other to form a ring, and D¹⁹ and D²² and/or D²⁰ and D²³ may be bonded to form a ring.

6. An optical recording medium according to claim 5, wherein
in the general formula (1), D¹ is a hydrogen atom, an alkyl group, an alkoxy group, an aryl group, an alkoxycarbonyl group, a cyano group, or a carbamoyl group, D² is a hydrogen atom, an alkyl group, an aryl group, or a heteroaryl group, D³ is an aryl group or a heteroaryl group, and D⁴ and D⁵ are independently a hydrogen atom or an alkyl group,
in the general formula (2), D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D¹¹ and D¹² are independently a hydrogen atom, an alkyl group, or an aryl group, and
in the general formula (3), D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D²² and D²³ are independently a hydrogen atom, an alkyl group, or an aryl group.

7. An optical recording medium according to claim 5, further comprising a phthalocyanine dye represented by the following general formula (4): 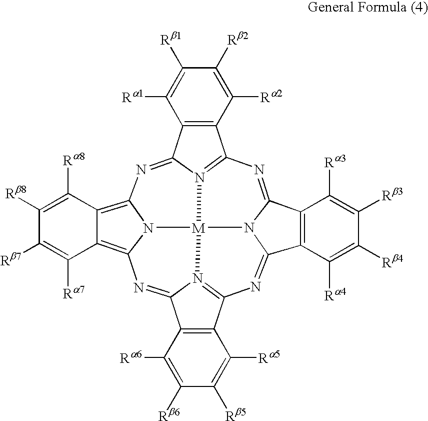
wherein R^{α1} to R^{α8} and R^{β1} to R^{β8} independently represent a hydrogen atom or a monovalent substituent, and M represents two hydrogen atoms, a metal, a metal oxide, or a metal having a ligand.

8. An optical recording medium according to claim 7, wherein R^{α1} to R^{α8} and R^{β1} to R^{β8} in the general formula (4) are independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

9. An optical recording medium comprising a substrate and a visible information recording layer formed thereon, visible information being recorded on the visible information recording layer by applying a laser light to the visible information recording layer repeatedly in an approximately same trajectory pattern, wherein
the visible information recording layer comprises at least one dye compound selected from
dye compounds represented by the following general formula (1): 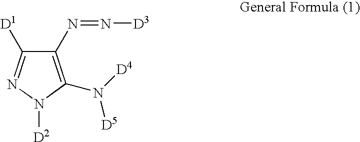
wherein D¹ represents a hydrogen atom or a monovalent substituent, D² represents a hydrogen atom or a monovalent substituent, D³ represents an aromatic group, D⁴ and D⁵ independently represent a hydrogen atom or a monovalent substituent, and the monovalent substituent may further have a substituent,
dye compounds represented by the following general formula (2): 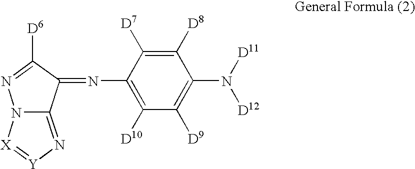
wherein D⁶ to D¹² independently represent a hydrogen atom or a monovalent substituent, D¹¹ and D¹² may be bonded to each other to form a ring, D⁸ and D¹¹ and/or D⁹ and D¹² may be bonded to form a ring, X and Y each represent a nitrogen atom or ═C(D¹³)- (in which D¹³ represents a hydrogen atom, an alkyl group, an aryl group, an alkoxy group, an aryloxy group, or an amino group), when both X and Y are C(D¹³)- two D¹³'s in X and Y may be bonded to each other to form a saturated or unsaturated carbocyclic ring, and the monovalent substituent may further have a substituent, and
dye compounds represented by the following general formula (3): 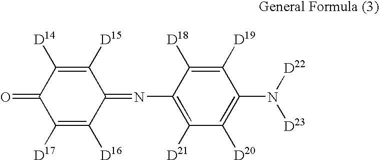
wherein D¹⁴ to D²¹ independently represent a hydrogen atom or a monovalent substituent, D²² and D²³ independently represent a hydrogen atom or a monovalent substituent, D²² and D²³ may be bonded to each other to form a ring, and D¹⁹ and D²² and/or D²⁰ and D²³ may be bonded to form a ring.

10. An optical recording medium according to claim 9, wherein
in the general formula (1), D¹ is a hydrogen atom, an alkyl group, an alkoxy group, an aryl group, an alkoxycarbonyl group, a cyano group, or a carbamoyl group, D² is a hydrogen atom, an alkyl group, an aryl group, or a heteroaryl group, D³ is an aryl group or a heteroaryl group, and D⁴ and D⁵ are independently a hydrogen atom or an alkyl group,
in the general formula (2), D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D¹¹ and D¹² are independently a hydrogen atom, an alkyl group, or an aryl group, and
in the general formula (3), D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D²² and D²³ are independently a hydrogen atom, an alkyl group, or an aryl group.

11. An optical recording medium according to claim 9, further comprising a phthalocyanine dye represented by the following general formula (4): 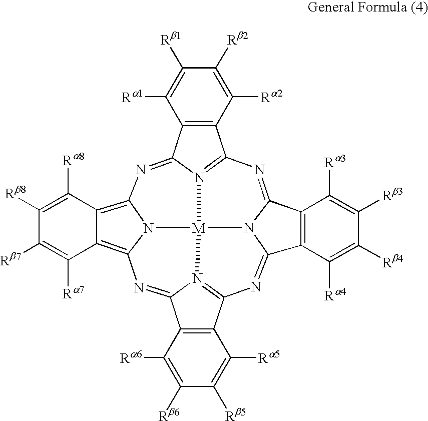
wherein R^{α1} to R^{α8} and R^{β1} to R^{β8} independently represent a hydrogen atom or a monovalent substituent, and M represents two hydrogen atoms, a metal, a metal oxide, or a metal having a ligand.

12. An optical recording medium according to claim 11, wherein R^{α1} to R^{α8} and R^{β1} to R^{β8} in the general formula (4) are independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

13. A method of using a dye compound as a material of a visible information recording layer in an optical recording medium comprising a substrate and the visible information recording layer formed thereon, visible information being recorded on the visible information recording layer by applying a laser light to the visible information recording layer repeatedly in an approximately same trajectory pattern while oscillating the laser light in a radial direction of the substrate, wherein
the material of the visible information recording layer comprises at least one dye compound selected from
dye compounds represented by the following general formula (1): 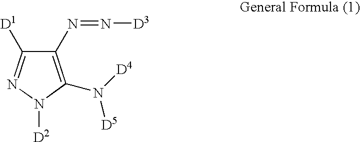
wherein D¹ represents a hydrogen atom or a monovalent substituent, D² represents a hydrogen atom or a monovalent substituent, D³ represents an aromatic group, D⁴ and D⁵ independently represent a hydrogen atom or a monovalent substituent, and the monovalent substituent may further have a substituent,
dye compounds represented by the following general formula (2): 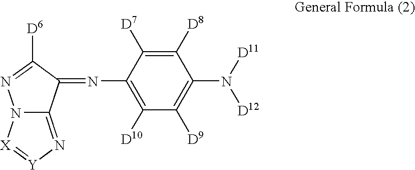
wherein D⁶ to D¹² independently represent a hydrogen atom or a monovalent substituent, D¹¹ and D¹² may be bonded to each other to form a ring, D⁸ and D¹¹ and/or D⁹ and D¹² may be bonded to form a ring, X and Y each represent a nitrogen atom or ═C(D¹³)- (in which D¹³ represents a hydrogen atom, an alkyl group, an aryl group, an alkoxy group, an aryloxy group, or an amino group), when both X and Y are C(D¹³)- two D¹³'s in X and Y may be bonded to each other to form a saturated or unsaturated carbocyclic ring, and the monovalent substituent may further have a substituent, and
dye compounds represented by the following general formula (3): 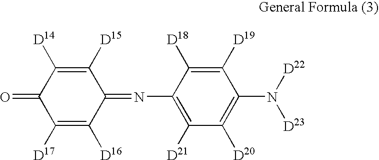
wherein D¹⁴ to D²¹ independently represent a hydrogen atom or a monovalent substituent, D²² and D²³ independently represent a hydrogen atom or a monovalent substituent, D²² and D²³ may be bonded to each other to form a ring, and D¹⁹ and D²² and/or D²⁰ and D²³ may be bonded to form a ring.

14. A method according to claim 13, wherein
in the general formula (1), D¹ is a hydrogen atom, an alkyl group, an alkoxy group, an aryl group, an alkoxycarbonyl group, a cyano group, or a carbamoyl group, D² is a hydrogen atom, an alkyl group, an aryl group, or a heteroaryl group, D³ is an aryl group or a heteroaryl group, and D⁴ and D⁵ are independently a hydrogen atom or an alkyl group,
in the general formula (2), D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D¹¹ and D¹² are independently a hydrogen atom, an alkyl group, or an aryl group, and
in the general formula (3), D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D²² and D²³ are independently a hydrogen atom, an alkyl group, or an aryl group.

15. A method according to claim 13, wherein the optical recording medium further comprises a phthalocyanine dye represented by the following general formula (4): 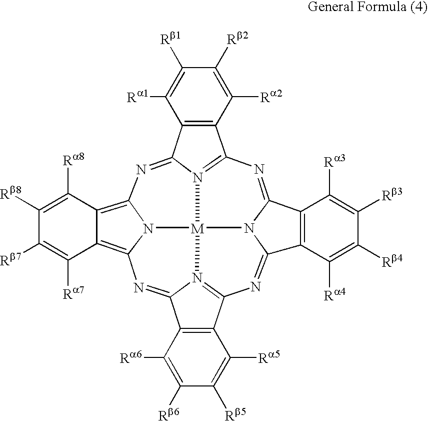
wherein R^{α1} to R^{α8} and R^{β1} to R^{β8} independently represent a hydrogen atom or a monovalent substituent, and M represents two hydrogen atoms, a metal, a metal oxide, or a metal having a ligand.

16. A method according to claim 15, wherein R^{α1} to R^{α8} and R^{β1} to R^{β8} in the general formula (4) are independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.

17. A method of recording visible information on an optical recording medium comprising a substrate and a visible information recording layer formed thereon, comprising applying a laser light to the visible information recording layer repeatedly in an approximately same trajectory pattern while oscillating the laser light in a radial direction of the substrate, wherein
the visible information recording layer comprises at least one dye compound selected from
dye compounds represented by the following general formula (1): 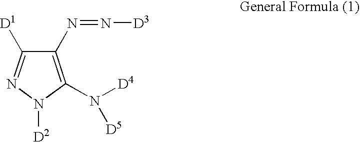
wherein D¹ represents a hydrogen atom or a monovalent substituent, D² represents a hydrogen atom or a monovalent substituent, D³ represents an aromatic group, D⁴ and D⁵ independently represent a hydrogen atom or a monovalent substituent, and the monovalent substituent may further have a substituent,
dye compounds represented by the following general formula (2): 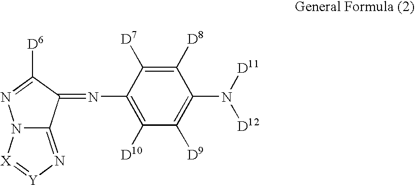
wherein D⁶ to D¹² independently represent a hydrogen atom or a monovalent substituent, D¹¹ and D¹² may be bonded to each other to form a ring, D⁸ and D¹¹ and/or D⁹ and D¹² may be bonded to form a ring, X and Y each represent a nitrogen atom or ═C(D¹³)- (in which D¹³ represents a hydrogen atom, an alkyl group, an aryl group, an alkoxy group, an aryloxy group, or an amino group), when both X and Y are C(D¹³)-, two D¹³'s in X and Y may be bonded to each other to form a saturated or unsaturated carbocyclic ring, and the monovalent substituent may further have a substituent, and
dye compounds represented by the following general formula (3): 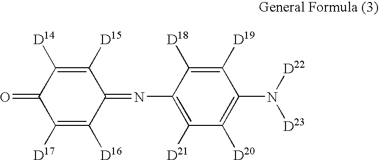
wherein D¹⁴ to D²¹ independently represent a hydrogen atom or a monovalent substituent, D²² and D²³ independently represent a hydrogen atom or a monovalent substituent, D²² and D²³ May be bonded to each other to form a ring, and D¹⁹ and D²² and/or D²⁰ and D²³ may be bonded to form a ring.

18. A method according to claim 17, wherein
in the general formula (1), D¹ is a hydrogen atom, an alkyl group, an alkoxy group, an aryl group, an alkoxycarbonyl group, a cyano group, or a carbamoyl group, D² is a hydrogen atom, an alkyl group, an aryl group, or a heteroaryl group, D³ is an aryl group or a heteroaryl group, and D⁴ and D⁵ are independently a hydrogen atom or an alkyl group,
in the general formula (2), D⁶ to D¹⁰ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D¹¹ and D¹² are independently a hydrogen atom, an alkyl group, or an aryl group, and
in the general formula (3), D¹⁴ to D²¹ are independently a hydrogen atom, a halogen atom, an alkyl group, an alkoxy group, an aryl group, an aryloxy group, a cyano group, an acylamino group, a sulfonylamino group, a ureido group, an alkoxycarbonylamino group, an alkylthio group, an arylthio group, an alkoxycarbonyl group, a carbamoyl group, a sulfamoyl group, a sulfonyl group, an acyl group, or an amino group, and D²² and D²³ are independently a hydrogen atom, an alkyl group, or an aryl group.

19. A method according to claim 17, wherein the optical recording medium further comprises a phthalocyanine dye represented by the following general formula (4): 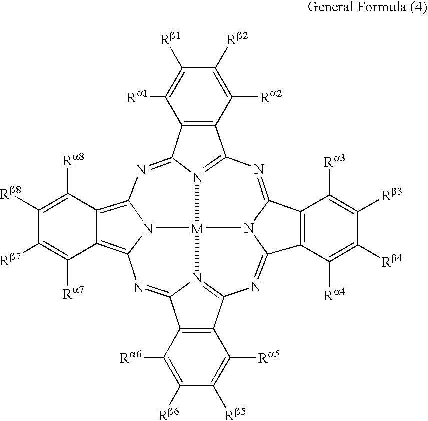
wherein R^{α1} to R^{α8} and R^{β1} to R^{β8} independently represent a hydrogen atom or a monovalent substituent, and M represents two hydrogen atoms, a metal, a metal oxide, or a metal having a ligand.

20. A method according to claim 19, wherein R^{α1} to R^{α8} and R^{β1} to R^{β8} in the general formula (4) are independently a hydrogen atom, a halogen atom, a cyano group, a nitro group, a formyl group, a carboxyl group, a sulfo group, an alkyl group having 1 to 20 carbon atoms, an aryl group having 6 to 14 carbon atoms, an aralkyl group having 7 to 15 carbon atoms, a heterocyclic group having 1 to 10 carbon atoms, an alkoxy group having 1 to 20 carbon atoms, an aryloxy group having 6 to 14 carbon atoms, an acyl group having 2 to 21 carbon atoms, an alkylsulfonyl group having 1 to 20 carbon atoms, an arylsulfonyl group having 6 to 20 carbon atoms, a carbamoyl group having 1 to 25 carbon atoms, a sulfamoyl group having 0 to 32 carbon atoms, an alkoxycarbonyl group having 2 to 21 carbon atoms, an aryloxycarbonyl group having 7 to 15 carbon atoms, an acylamino group having 2 to 21 carbon atoms, a sulfonylamino group having 1 to 20 carbon atoms, or an amino group having 0 to 36 carbon atoms.
